(19) United States
(12) Patent Application Publication
(10) Pub. No.: US 2007/0220269 A1
(43) Pub. Date: Sep. 20, 2007

(54) Image forming apparatus, image forming apparatus controlling method, computer program product

(76) Inventor: Hiroaki Suzuki, Chiba (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/713,146

(22) Filed: Mar. 2, 2007

(30) Foreign Application Priority Data
Mar. 3, 2006 (JP) 2006-058546
Feb. 7, 2007 (JP) 2007-028342

(51) Int. Cl. H04L 9/32; H04L 9/00; G06K 9/00; G06F 17/30; H04K 1/00; G06F 7/04; H03M 1/68; H04N 7/16

(52) U.S. Cl. 713/182; 713/185; 713/159; 713/172; 726/27; 726/2

(57) ABSTRACT

With personal information and confidential information being output through a direct operation from an output device, the operator can reliably obtain such information in person. Also, such confidential information can be retrieved from his or her own personal computer without being carried in a form of a recording medium. Therefore, problems, such as loss of a recording medium, never occur. In addition to security at the time of establishing communication, authentication of personal identification allows more security to be ensured. Furthermore, an exemplary operation is performed with a combination of an IC card and a password, and validity of the IC card is more ensured through an external authentication server.

### PRIORITY

The present application claims priority to and incorporates by reference the entire contents of Japanese priority documents, 2006-058546, filed in Japan on Mar. 3, 2006, and 2007-028342, filed in Japan on Feb. 7, 2007.

### BACKGROUND OF THE INVENTION

1. Field of the Invention

The present invention relates to an image forming apparatus including digital equipment handling monochrome images and color images, and a method and a computer program product for controlling such an apparatus. In more detail, the present invention relates to a digital Multi Function Peripheral (MFP) having a copy function, a printer function, a facsimile function, and other functions; a method, a computer program product for controlling such an MFP; and a recording medium.

2. Description of the Related Art

When print data is output from a shared personal computer to an image forming apparatus electrically coupled to that personal computer and others, an output printed matter can be obtained instantly after a print instruction. Also, when a highly-confidential document file or personal information stored in or a recording medium such as a portable memory or a Compact Disc Read Only Memory (CD-ROM) is opened on the shared personal computer, such confidential file often has to be carried. This poses a problem of possible loss of the recording medium itself, leading to possible leakage of the highly-confidential document file or information.

For example, one technology for preventing such leakage and other problems is disclosed in Japanese Patent Application Laid-Open No. 2000-141826. In the invention disclosed in this document, an identifier (ID) is provided at the time of printing at the image forming apparatus, and an output is allowed only when a user enters the ID in the apparatus.

The technology disclosed in Japanese Patent Application Laid-Open No. 2000-141826 is effective when confidential document or personal information are printed out. However, if the image forming apparatus is not immediately near the user and an intended output result is not obtained, the user has to return to the personal computer to set it in order to produce an output again.

In this manner, when the device used by the user and the image output apparatus are far away from each other, it is inconvenient. Also, even if the image forming apparatus is near the user, when a set password is used for each piece of the information mentioned above to increase security, a careless miss (human error) cannot be avoided, such as inadvertently forgetting to present the password in the presence of urgency, for example.

Japanese Patent Application Laid-Open No. 2002-259092 discloses an output example from a remote device. Japanese Patent Application Laid-Open No. 2004-287624 discloses an example in which an output is produced from a mobile device based on authentication by the user. Japanese Patent Application Laid-Open No. 2004-110679 discloses an output example with security being ensured from a mobile device. These examples relate to a technology regarding an output from a personal computer (hereinafter, simply “PC”) to an image forming apparatus.

Japanese Patent Application Laid-Open No. 2002-32205 discloses a technology in which an output is once stored on a server and, at the same time, is automatically provided with identification data and, at the time of output, the identification data is entered from an output device for searching a server. However, in this technology, a desired document has to be reliably stored in advance in the server. Also, Japanese Patent No. 3356572 discloses a technology in which a data transfer request is sent through a network to a PC specified from an operating unit of a digital Multi Functional Peripheral (MFP).

The problems mentioned above can be solved if a desired output can be retrieved by directly accessing from the image forming apparatus to each PC storing confidential information. However, since the connection is made through a network, it is indispensable to ensure security.

Furthermore, issuing an output instruction from each PC through an image forming apparatus unit that the instruction operation itself is supposed to be performed by the user in person, and the confidential document can be reliably obtained by this user in person.

### SUMMARY OF THE INVENTION

An image forming apparatus, image forming apparatus controlling method, computer program product are described. In one embodiment, an image forming apparatus comprises a communicating unit that establishes communication with a user device selected as a connection destination; a selection input unit that provides a selection or input for establishing security of communication with the user device as the connection destination through the communicating unit; and an operating unit that enters an output request from the user device with security established and output information from the user device, determines whether the output request from the user device with security established is valid, and operates the output information according to the output request from the user device with security established when the output request is valid.

### BRIEF DESCRIPTION OF THE DRAWINGS

FIG. 1 is a block configuration diagram of an image forming apparatus according to one embodiment of the present invention;

FIG. 2 is a drawing of a system configuration example of one embodiment of a system including the image forming apparatus according to one embodiment of the present invention;

FIG. 3 is a drawing of a system configuration example of another embodiment of a system including the image forming apparatus according to one embodiment of the present invention;

FIG. 4 is a drawing of a system configuration example of still another embodiment of a system including the image forming apparatus according to one embodiment of the present invention;

FIG. 5 is a flowchart of a first operation example of the image forming apparatus according to an embodiment of the present invention;

FIG. 6 is a flowchart of a second operation example of the image forming apparatus according to an embodiment of the present invention;

FIG. 7 is a flowchart of a third operation example of the image forming apparatus according to an embodiment of the present invention;

FIG. 8 is a partial flowchart of a fourth operation example of the image forming apparatus according to an embodiment of the present invention;

FIG. 9 is a partial flowchart of the fourth operation example of the image forming apparatus according to an embodiment of the present invention;

FIG. 10 is a partial flowchart of a fifth operation example of the image forming apparatus according to an embodiment of the present invention;

FIG. 11 is a partial flowchart of the fifth operation example of the image forming apparatus according to an embodiment of the present invention;

FIG. 12 is a partial flowchart of a sixth operation example of the image forming apparatus according to an embodiment of the present invention;

FIG. 13 is a partial flowchart of the sixth operation example of the image forming apparatus according to an embodiment of the present invention;

FIG. 14 is a partial flowchart of the sixth operation example of the image forming apparatus according to an embodiment of the present invention;

FIG. 15 is a partial flowchart of a seventh operation example of the image forming apparatus according to an embodiment of the present invention;

FIG. 16 is a partial flowchart of the seventh operation example of the image forming apparatus according to an embodiment of the present invention;

FIG. 17 is a partial flowchart of the seventh operation example of the image forming apparatus according to an embodiment of the present invention;

FIG. 18 is a partial flowchart of an eighth operation example of the image forming apparatus according to an embodiment of the present invention;

FIG. 19 is a partial flowchart of the eighth operation example of the image forming apparatus according to an embodiment of the present invention;

FIG. 20 is a partial flowchart of the eighth operation example of the image forming apparatus according to an embodiment of the present invention;

FIG. 21 is a partial flowchart of a ninth operation example of the image forming apparatus according to an embodiment of the present invention;

FIG. 22 is a partial flowchart of the ninth operation example of the image forming apparatus according to an embodiment of the present invention;

FIG. 23 is a partial flowchart of the ninth operation example of the image forming apparatus according to an embodiment of the present invention;

FIG. 24 is a sequence diagram depicting exchanges among an MFP as the image forming apparatus according to an embodiment of the present invention, a personal computer, an authentication server, and an accounting server;

FIG. 25 is a drawing illustrating the accounting server depicted in FIG. 24;

FIG. 26 is a drawing illustrating the authentication server depicted in FIG. 24;

FIG. 27 is another drawing illustrating the authentication server depicted in FIG. 24;

FIG. 28 is a drawing illustrating the personal computer depicted in FIG. 24;

FIG. 29 is another drawing illustrating the accounting server depicted in FIG. 24; and

FIG. 30 is another drawing illustrating the authentication server depicted in FIG. 24.

### DETAILED DESCRIPTION OF THE PREFERRED EMBODIMENTS

According to an embodiment of the present invention, an image forming apparatus includes a communicating unit that establishes communication with a user device selected as a connection destination; a selection input unit that provides a selection or input for establishing security of communication with the user device as the connection destination through the communicating unit; and an operating unit that enters an output request from the user device with security established and output information from the user device, determines whether the output request from the user device with security established is valid, and operates the output information according to the output request from the user device with security established when the output request is valid.

According to another embodiment of the present invention, an image forming method includes establishing communication with a user device selected as a connection destination; selecting or receiving input for establishing security of communication with the user device as the connection destination; and entering an output request from the user device with security established and output information from the user device, determining whether the output request from the user device with security established is valid, and operating the output information according to the output request from the user device with security established when the output request is valid.

According to still another embodiment of the present invention, a computer program product causes a computer to execute the above method.

The above and other embodiments, features, advantages and technical and industrial significance of this invention will be better understood by reading the following detailed description of presently preferred embodiments of the invention, when considered in connection with the accompanying drawings.

Exemplary embodiments of the present invention are described in detail below with reference to accompanying drawings.

### FIRST OPERATION EXAMPLE

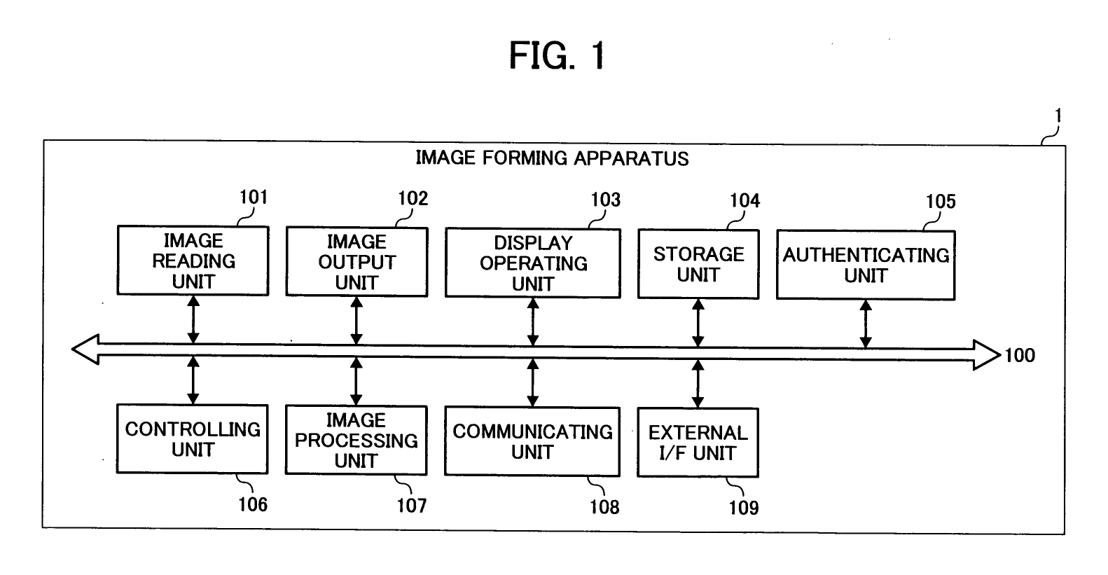

An operation example of the image forming apparatus according to an embodiment of the present invention is explained based on FIG. 1, which is a system block diagram.

In the present operation example, an MFP is assumed as one example of the image forming apparatus, and the operation example is explained below by using this MFP.

Here, the MFP is used to call integrated equipment having a plurality of functions, such as a copy function, a printer function, a facsimile function, and a communication function. Therefore, the MFP may be arbitrary as long as it has a plurality of these functions, and it may appear to be any of a copier, a printer, and a facsimile. In general, these are digital equipment and, in principle, have a computer function and also a communication function allowing connection to a network, such as the Internet or an intranet.

As depicted in FIG. 1, a system bus 100 in an MFP has connected thereto members having functions as explained below, for example, members 101 to 109 as depicted in FIG. 1. Through the bus 100, various pieces of data are exchanged.

As depicted in FIG. 1, the image forming apparatus in the present operation example includes: an image reading unit 101 that reads a document of a monochrome image or a color image (the image reading unit is exemplarily implemented by a scanner or a digital still camera); an image output unit 102 that outputs an image in monochrome or color (the image output unit is exemplarily implemented by a printer (including an electrophotography printer and an inkjet printer); a display operating unit 103 that, for example, determines settings of functions for use in the apparatus, displays information, and operates the apparatus (the display operating unit is exemplarily implemented by a display device in a form of an operation panel or a touch panel in combination with a numeric keypad and other input buttons); a storage unit 104 that stores image data, control parameters, and others (the storage unit is exemplarily implemented by a unit that allows permanent or temporary storage, such as a hard disk (HD), a Random Access Memory (RAM), a Read Only Memory (ROM), or the like); and an authenticating unit 105 that performs personal authentication (the authenticating unit is implemented by an IC card reader, and other devices using biometrics, such as each of patterns of fingerprints, iris, face, vein, voice, and others, and a cellular phone having a biometrics authentication function and an electronic money function may be used as an authenticating unit (for the former, refer to Japanese Patent No. 3356144 and, for the latter, refer to Japanese Patent Application Laid-Open No. 2002-269484).

One of the most simple authentication methods is authentication through a password. To ensure security, however, an authentication method using a combination of a plurality of authentication methods is preferably adopted. In the present operation example, an authentication method in combination of an IC card and a password is explained. Furthermore, the image forming apparatus includes: a controlling unit 106 that controls each member (the controlling unit is exemplarily implemented by a controller, a Central Processing Unit (CPU), or the like); an image processing unit 107 that performs various image processes at the image reading unit and the image output unit (the image processing unit is exemplarily implemented by an image processor); a communicating unit 108 that communicates with the outside through a Large-Area Network (LAN) or wirelessly (the communicating unit is exemplarily implemented by a Network Interface Card (NIC)); and an external interface (I/F) unit 109 that produces inputs and outputs of information to and from the outside using a scheme other than that of the communicating unit (the external I/F unit is exemplarily implemented by a Universal Serial Bus (USB) port and can be any I/F that can use various storage medium).

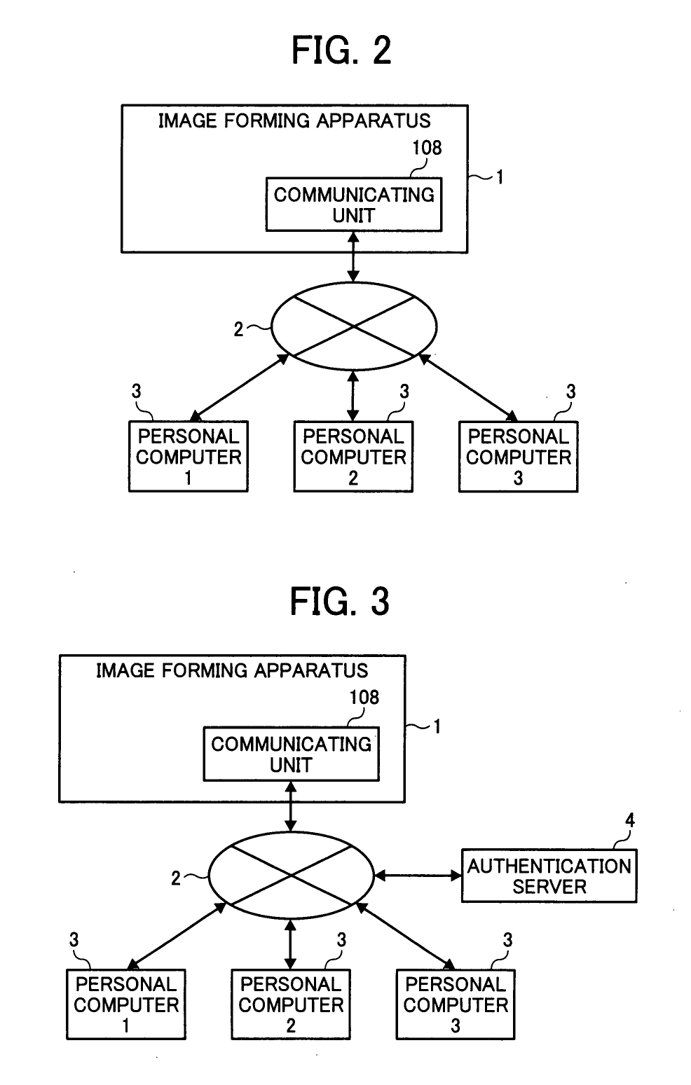

FIG. 2 is a drawing of a configuration example in which the communicating unit 108 of the MFP as the information forming apparatus is connected to a plurality of PCs (personal computers) 1 to 3 through a network. In this configuration example, the number of PCs (user terminals) connected to the network is three. Needless to say, however, the number of PCs according to the embodiment is not meant to be restricted to three. Also, the number of user terminals (PCs) may be one.

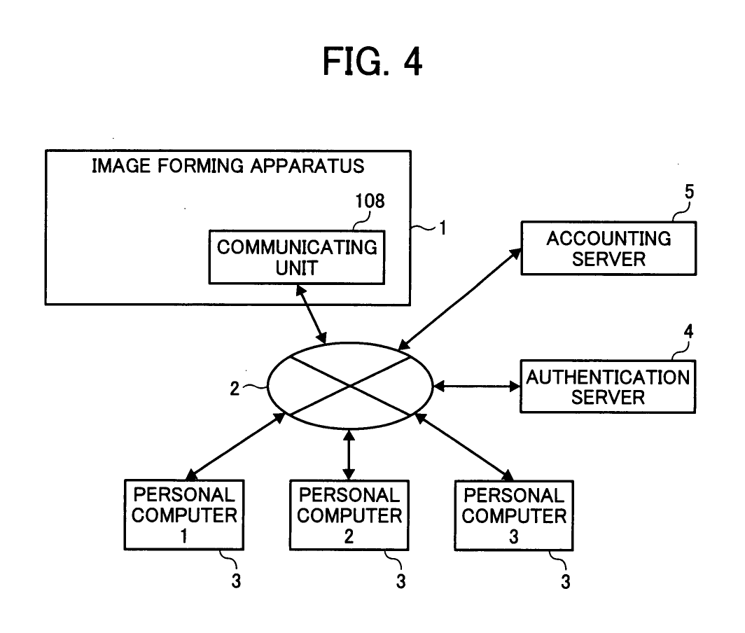

A feature of an embodiment of the present invention is that a connection destination, for example, a PC 3, is selected from the MFP and, after a connection between the PC 3 and the MFP is established, a remote access from the MFP to the PC is allowed. Preferably, as depicted in FIG. 3 or FIG. 4, in an exemplary system including the MFP, an MFP (image forming apparatus) 1 and one or more user terminals (for example, PCs) 3 are connected to one another through a network 2 and further connected to an authentication server 4 through the network (refer to FIG. 3). Furthermore, in another exemplary system including the MFP, an MFP 1 and one or more PCs 3 are connected to an accounting server 5 through a network.

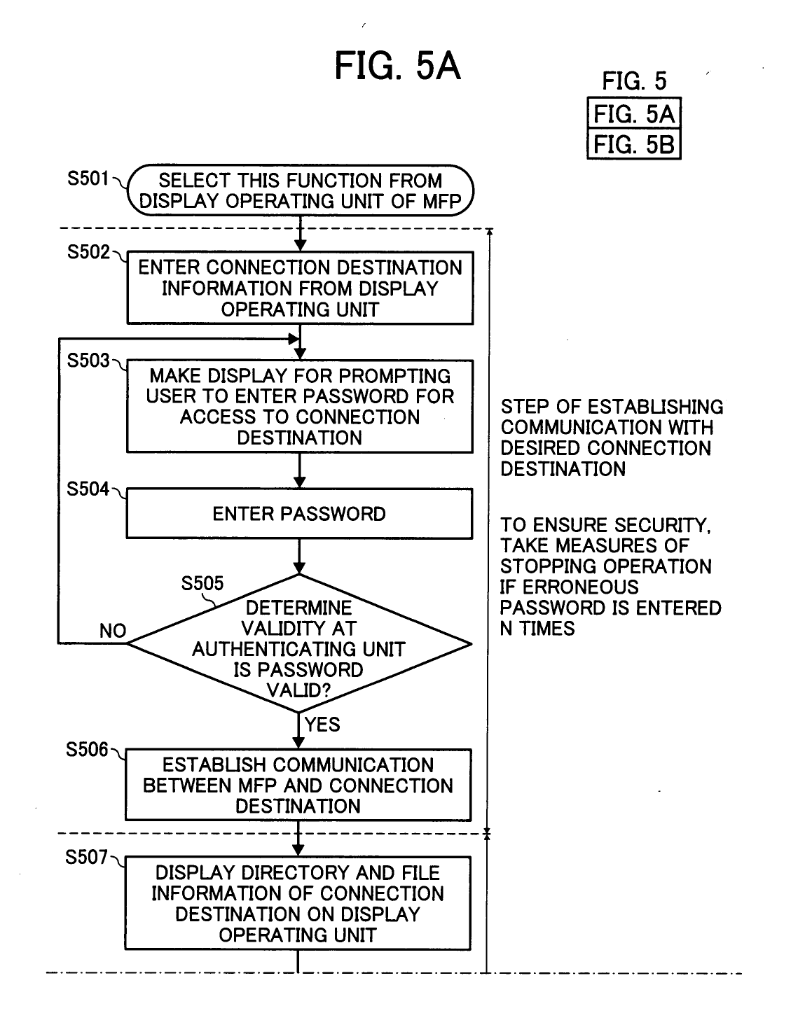

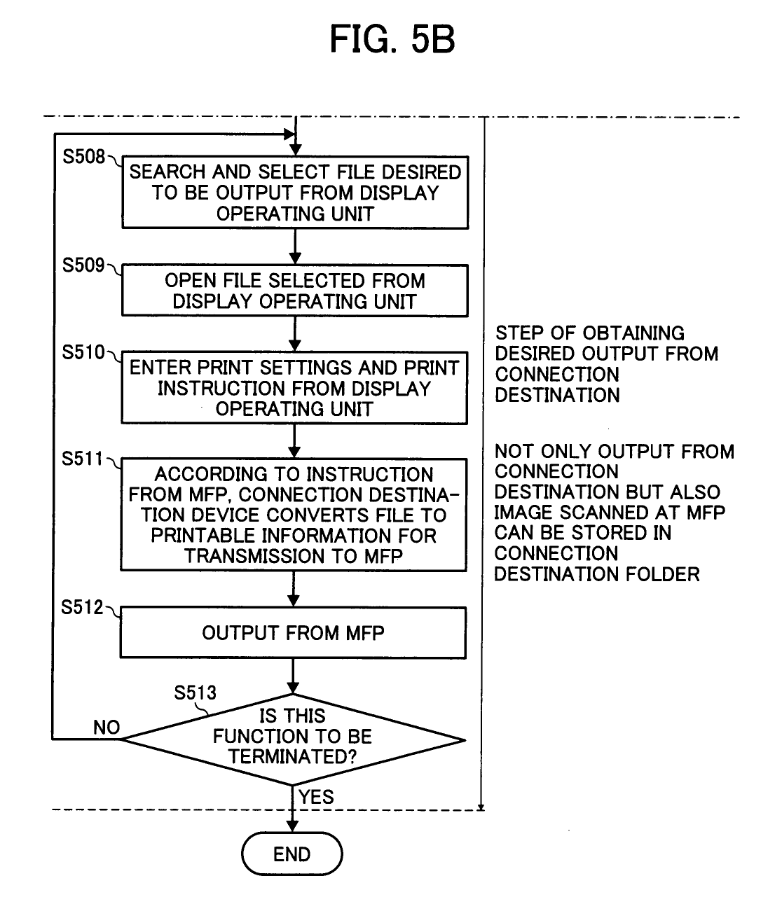

One example of a process flow at the MFP according to an embodiment of the present invention is depicted in FIG. 5, where the process flow is after a function of outputting an image is selected from the display operating unit of the MFP after security of communication with a connection destination is established. As depicted in FIG. 5, this process flow is broadly divided into the following two steps:

1. a step of establishing secure communication with a desired connection destination (secure communication unit communication with a specific desired connection destination without leakage of information) (S502 to S506); and

2. a step of obtaining a desired output from the connection destination (S507 to S513).

Step 1 above (S502 to S506) has a flow of performing communication with security ensured for accessing the MFP and the PCs. Also, a password for use herein is a password for secure communication, for example, a password for Virtual Private Network (VPN) connection. This password is different from a general login password to a PC.

For example, Secure Socket Layer(SSL)—VPN has currently attracted attention as secure communication. SSL is a scheme developed by Netscape Communication, and includes a protocol for encrypting confidential information and the like for transmission and reception through the Internet. VPN includes a service using a public line as a virtual dedicated line. SSL-VPN is a fusion of these two technologies, and has attracted attention.

Since SSL is supported by many Web browsers and mail software programs by default, it is easily used as a measure for remote access. Also, VPN has a lower-cost advantage compared with provision of a dedicated line, and therefore is effective for confidential information, personal information, electronic commerce, and others.

Step 2 above (S502 to S506) has a flow of specifying information in the PC from the MFP for output. In the present operation example, an example is depicted in which information in a PC, which is an access destination, is output from the MFP. Furthermore, by way of example, for a confidential document requested to be returned immediately while on the go, if the user is allowed to read this confidential document, the user can access a terminal of his or her company or his or her own to send (transmit) a document read by the image reading unit to a desired folder of a PC with a connection established (preferably, his or her own terminal), thereby transferring this confidential document. Then, the transferred confidential document is further transferred to another person with it contents being in a secret state and is then converted into a document on an MFP for the first time for obtainment. Then, the confidential document is deleted from his or her own terminal.

In such a case, a password for establishing a secure connection with an external device is entered, and the authenticating unit then determines whether this entered password is valid. To ensure security of the password, a measure can be taken such that the operation is stopped when an erroneous input is provided N times, for example. Such a portion of ensuring security is omitted in the flow of FIG. 5. Also, if there is an erroneous input, a clear password for clearing this erroneous input and subsequent first and second passwords for authentication may be entered for continuing authentication.

When a connection with the user's own company or terminal is established in this manner, a remote access from the MFP to the PC is enabled. Therefore, from the display operating unit, a file in the PC is specified, and a file desired to be printed is selected and a print instruction is issued. Also at this time, for example, an output may be produced after a password (any specific one of the clear password and the first and second passwords, a predetermined password for a confidential document, or the like) is entered for authentication.

### SECOND OPERATION EXAMPLE

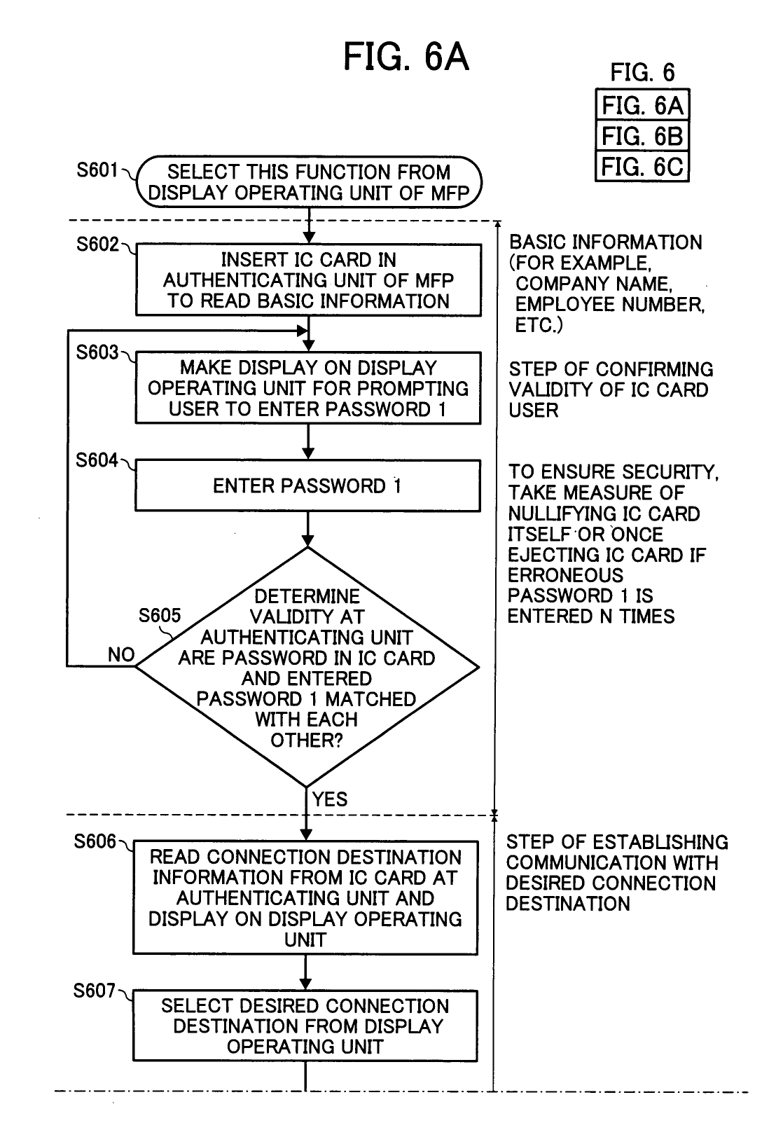

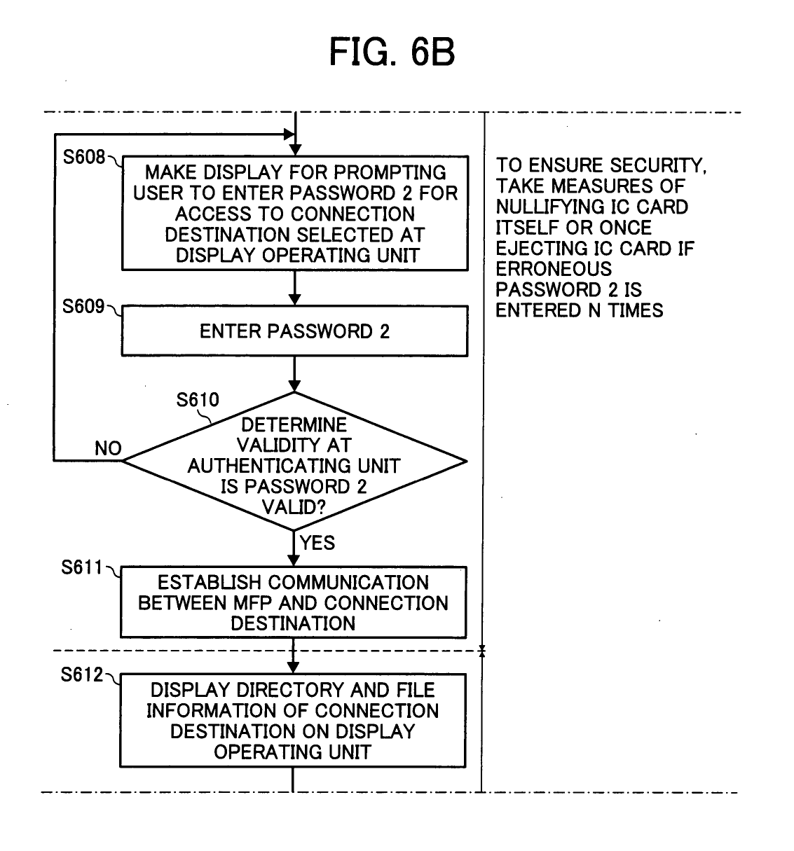

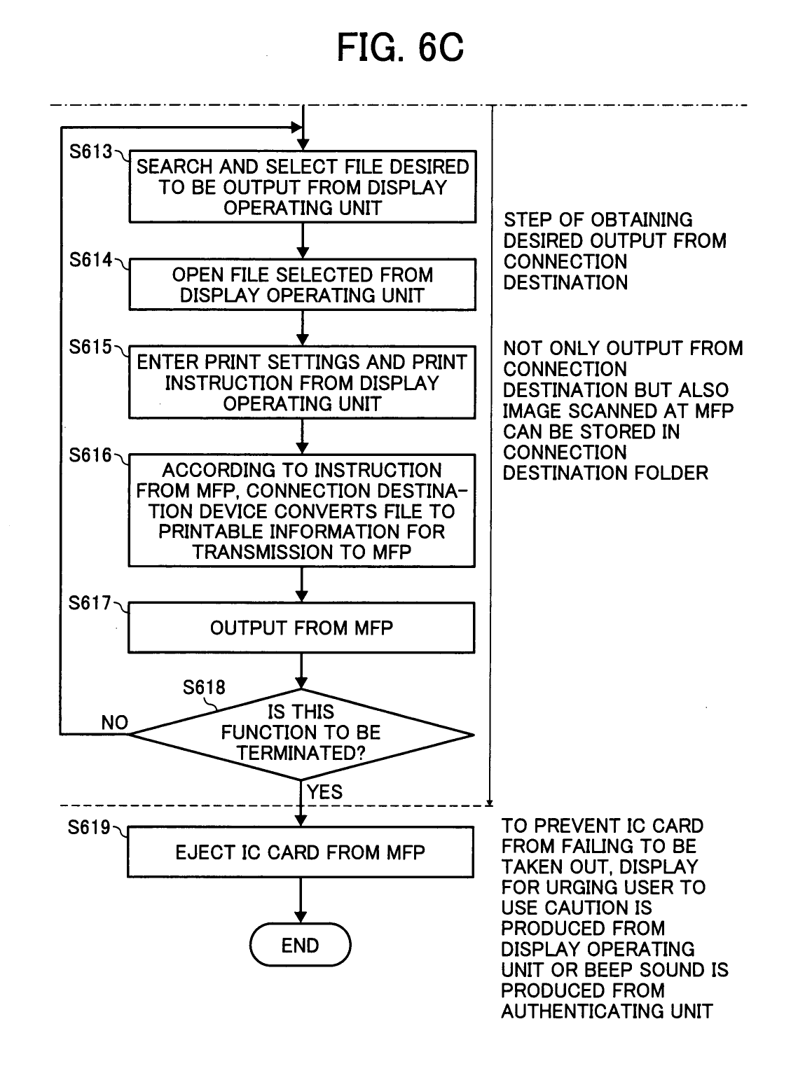

The present operation example is represented by a flow of processes after a function of ensuring validity of an IC card user and communication security is selected. To the first operation example, a step of confirming validity of the IC card user is added. With this, in this exemplary flow, unauthorized use of the IC card can be prevented. The flow exemplifying such processes is depicted in FIG. 6.

The IC card has previously stored therein information indispensable for using this function, such as information specifying the user himself or herself (personal information, such as company name, employee number, name, and others) as well as connection destination information for specifying a connection destination (for example, media access control (MAC) address). The connection destination address includes an Internet Protocol (IP) address or a MAC address. With this information being input, the PC 3, which is the only PC desired to be connected, can be found. The connection destination information includes at least one connection destination, but the number of connection destinations may be plural, and at least one can be selected as a desired connection destination.

First, validity of the IC card is confirmed. To avoid unauthorized use of an IC card stolen or found by a malicious third party and further an IC card having valid IC card information copied thereto, in the present operation example, the same password as that of a bank cash card is used for authenticating personal identification. This is determined by the authenticating unit whether the password stored in the IC card is matched with the entered password (steps S601 to S605).

In the flow depicted in FIG. 6, a loop is depicted for simplification in which the number of erroneous inputs of the password can be any. However, in view of security, if the number of erroneous inputs is equal to or more than N (three, for example, as with the bank cash card), the IC card can be nullified or the operation can be stopped, and then the cash card in use can be ejected. This is preferable because security can be ensured. Explanation of this preferable operation is omitted herein.

After authentication of the IC card owner has been established, the connection destination information stored on the IC card is read at the authenticating unit. This information is not necessarily information stored on the IC card, but may be directly entered from the display operating unit, or may be entered by downloading or displaying sophisticated information (high security information) stored on a user's own cellular phone for example onto a screen or the like and reading this information. Alternatively, such information may be entered via a recording medium or the like through the external I/F unit (steps S606 to S611).

Next, a password for establishing a secure connection with an external device is entered, and the authenticating unit determines whether the entered password is valid. Here, as with the password mentioned above, to ensure security of the password, the IC card is nullified and ejected (including discarding) if an erroneous input is repeated N times.

Once a connection is established, a remote access from the MFP to the PC is allowed. Therefore, a file on the PC is specified from the display operating unit, a file desired for print is selected, and a print instruction is entered (steps S612 to S618).

After the end of the operation, the user can be prompted to pay attention in order not to fail to take out the IC card. Also, to prevent the password from being stolen by the surrounding people at the time of entering the password, a password input unit can be implemented in a touch panel form with a bidirectional display device allowing only the person who enters the password to view the password and also allowing the entered password to be easily checked. In such a display device, the field of view is narrow on the order of 15 degrees, which can effectively prevent a spy photo.

### THIRD OPERATION EXAMPLE

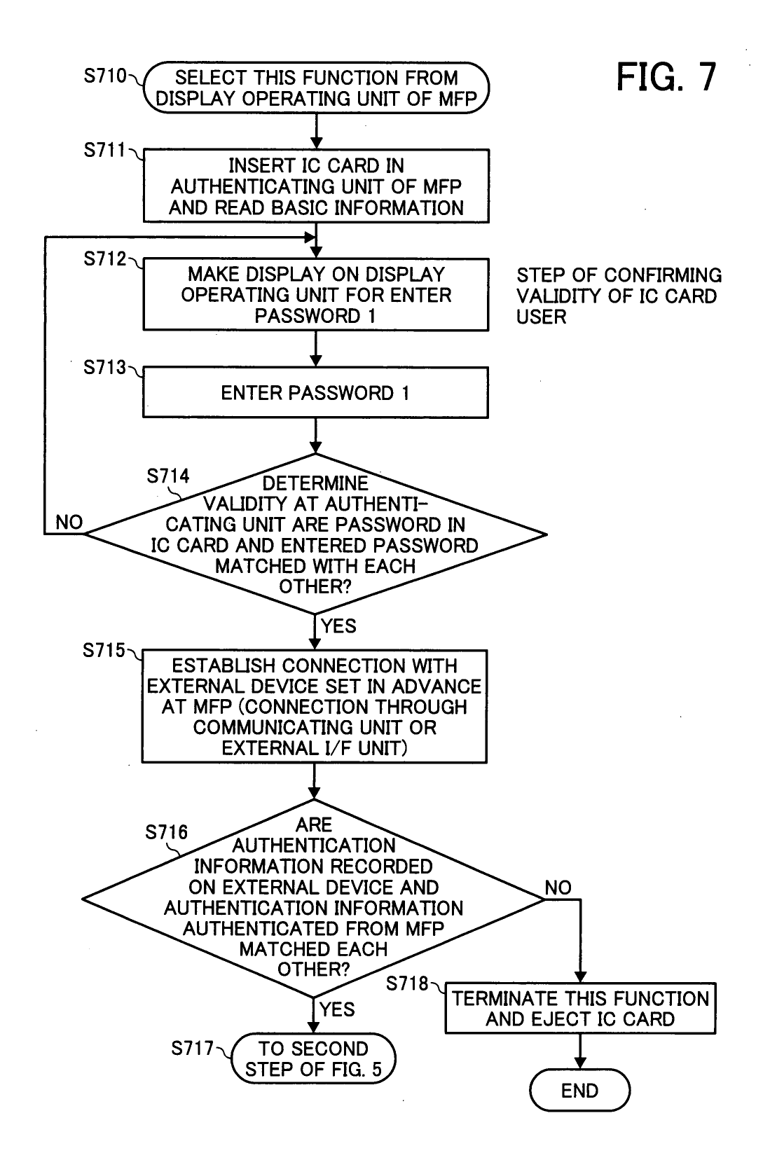

In contrast to the case in FIG. 6 (the second operation example) where the authenticating unit authenticates the IC card and the password, as depicted in the flowchart of the operation of a third operation example of FIG. 7, in addition to authentication in the second operation example, a flow of verifying whether information registered in advance in the IC card (such as company name and employee number) is matched with authentication information collectively managed outside of the MFP is explained.

In an embodiment of the present invention, at least one of authentication of the IC card and the password by the authenticating unit in the second operation example and the verification of the third embodiment can be performed.

As depicted in FIG. 3 or 4, when the number of employees is large or employee information is collectively managed, an authentication server having a database (DB) is provided on the network, and by accessing the server, it is determined whether the information entered from the device is correct, as in a step of confirming validity of the IC card user depicted in FIG. 7.

In an embodiment of the present invention, two or more operation examples can be included. For example, at least one of the step of confirming the validity of the IC card user in the second operation example (S710 to S718) and the step of confirming the validity of the IC card user in the third operation example can be performed solely or in combination.

Furthermore, in one example of the step of confirming the validity of the IC card user, authenticated information registered in a portable terminal (such as a cellular phone or a Personal Digital Assistant (PDA)) regarding its communication functions (cellular phone number, e-mail address, history information, and personal identification information in the portable terminal) can be used for authentication and confirmation.

### FOURTH OPERATION EXAMPLE

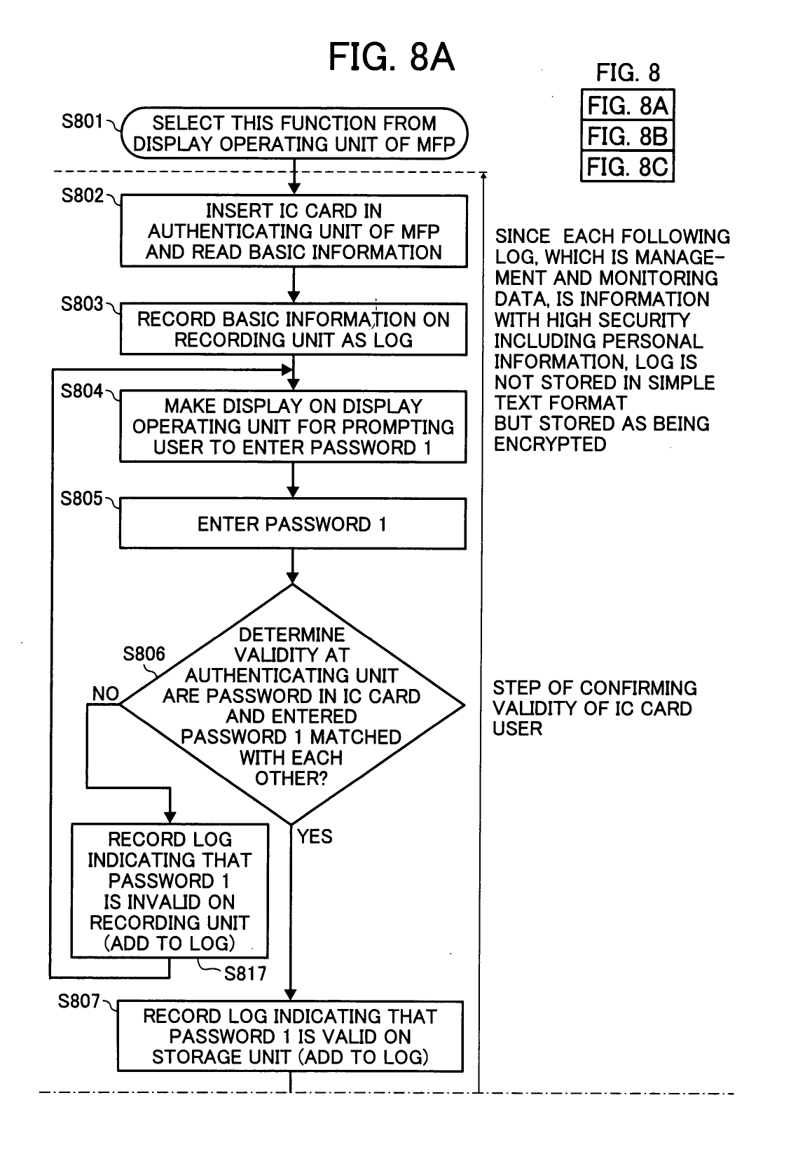

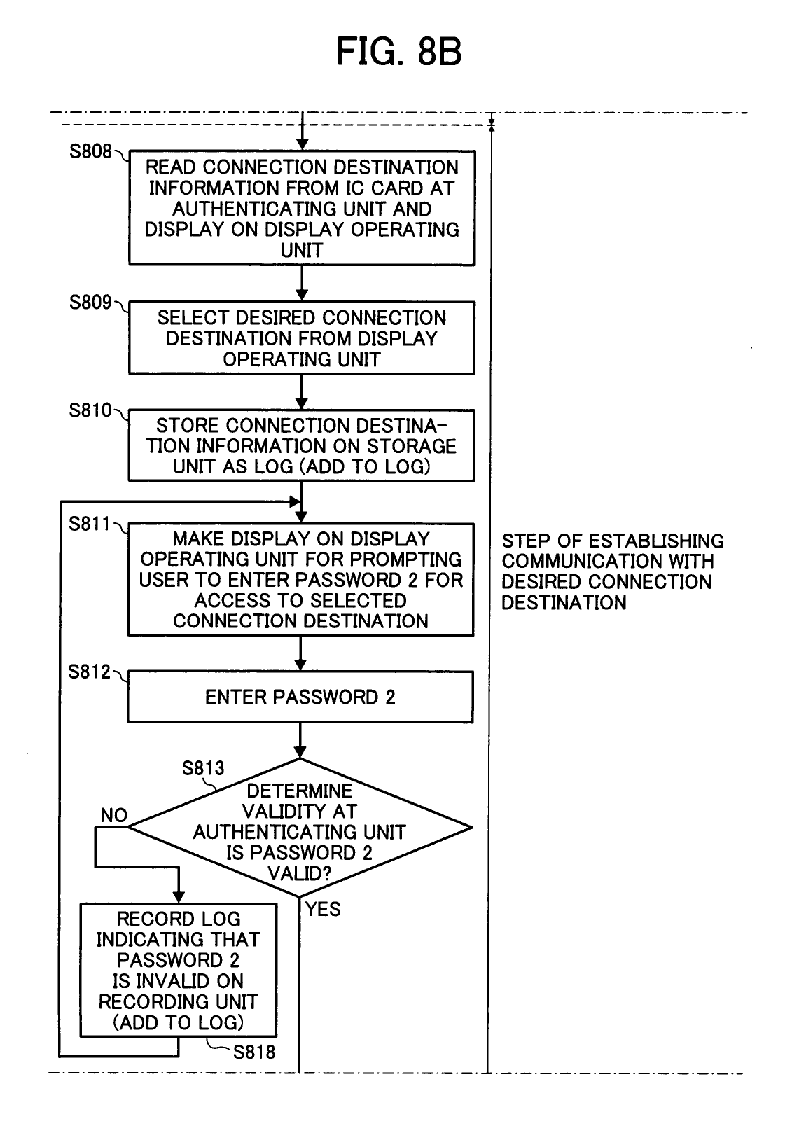

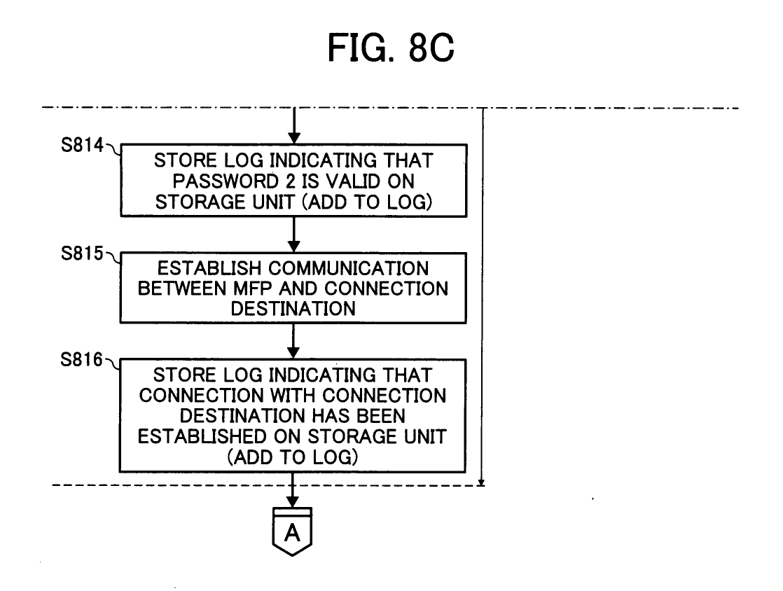

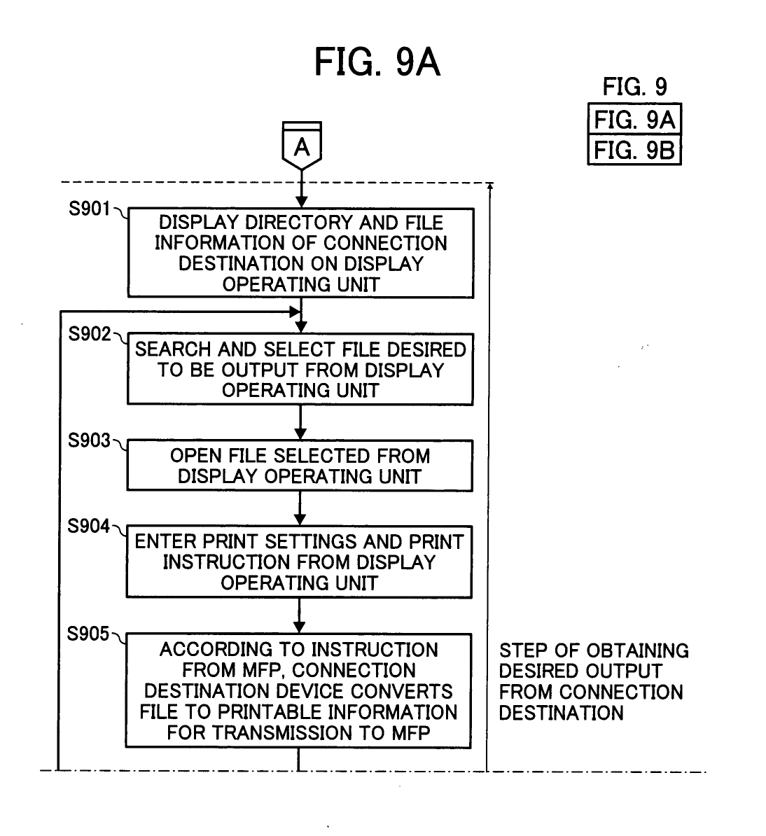

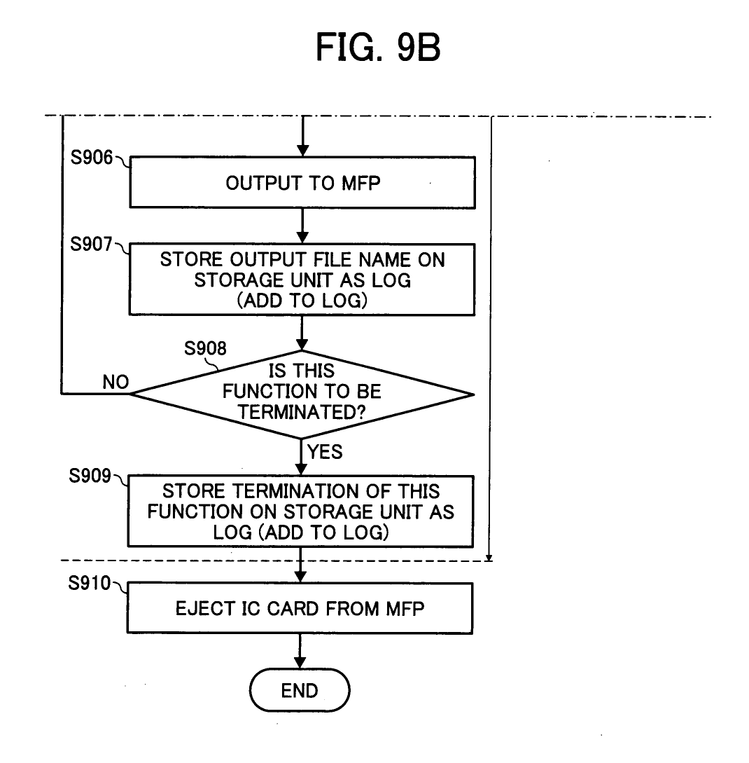

In a fourth operation example, logs (=history information) regarding who uses the IC card at which MFP are stored in the storage unit 104 of the MFP. This flow is depicted in FIGS. 8 and 9.

In contrast to the second operation example as depicted in FIG. 6, in the present operation example as depicted in FIGS. 8 to 9, a log is stored, or input information such as a password is added to the log to be left as history information. This flow is to suppress or prevent unauthorized use of the IC card. Also, personal information of an authorized user has to be protected.

To achieve this, a log is preferably not in a readily-readable ASCII file format but is encrypted (steps regarding log information added to the second operation example are denoted as S803, S807, S810, S814, S816, S817, S818, S916, and S918. In more detail, refer to FIGS. 8 and 9).

A log is stored when unauthorized use is found such as when a password 1 or a password 2 is invalid, and even when an authorized operation is performed. It is assumed that one log is stored for each operation.

That is, in FIG. 8, this function is first selected from the display operating unit of the MFP (step S801). Then, the IC card is inserted in the authenticating unit of the MFP to read basic information (step S802). The basic information is then stored in the storage unit as a log (step S803). A display of prompting the user to enter the password 1 is then made on the display operating unit (step S804). The password 1 is then entered (step S805). A validity determination (a determination of whether the password in the IC card and the entered password 1 are matched with each other) is then made at the authenticating unit (step S806). If they are matched (“Yes” at step S805), the procedure goes to the next step S807. If they are not matched (“No” at step S805), a log indicating that the password 1 is invalid is stored on the storage unit (such information may be added to the existing log, at step S817). The procedure then returns to step S804.

At step S807, a log indicating that the password 1 is valid is stored on the storage unit (such information may be added to the existing log). Then, connection destination information in the IC card is read at the authenticating unit, and is displayed on the display operating unit (step S808). A desired connection destination is then selected from the display operating unit (step S809). The selected connection destination information is then stored on the storage unit as a log (such information may be added to the existing log, at step S810). A display of prompting the user to enter the password 2 for access to the selected connection destination is then made on the display operating unit (step S811). Then, the password 2 is entered (step S812). A validity determination (determination of whether the password 2 is valid) is then made at the authenticating unit (step S813). If it is valid (“Yes” at step S813), the procedure goes to step S814. If it is invalid (“No” at step S813), a log indicating that the password 2 is invalid is stored on the storage unit (such information may be added to the existing log, at step S818). At step S814, a log indicating that the password 2 is valid is stored on the storage unit (such information may be added to the existing log). Then, a communication between the MFP and the connection destination is established (step S815). Then, a log indicating that the connection with the connection destination has been established is stored on the storage unit (such information may be added to the existing log) (step S816).

In FIG. 9, a directory and file information of the connection destination are displayed on the display operating unit (step S901). Then, a desired file to be output is searched and selected from the display operating unit (step S902). The file selected from the display operating unit is then opened (step S903). Then, print settings and a print instruction are entered from the display operating unit (step S904). According to the instruction from the MFP, the connection destination device converts the file to printable information for transmission to the MFP (step S905), and the information is output from the MFP (step S906). The name of the output file is stored on the storage unit as a log (such information may be added to the existing log), and then a determination of whether this function is to be terminated is made (step S908). If this function is to be terminated (“Yes” at step S908), the procedure goes to the next step S909. If this function is not to be terminated (“No” at step S908), the procedure returns to step S902. At step S909, termination of this function is stored on the storage unit as a log (such information may be added to the existing log), and then the IC card is ejected from the MFP for termination (step S910).

### FIFTH OPERATION EXAMPLE

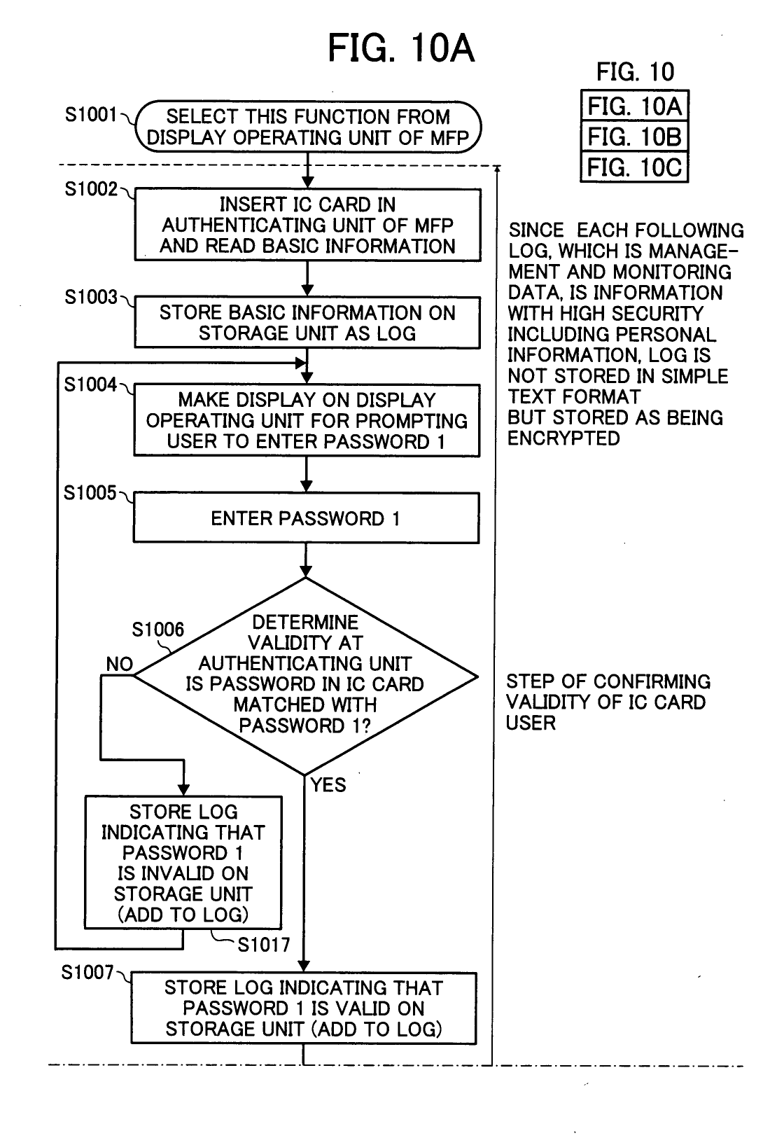

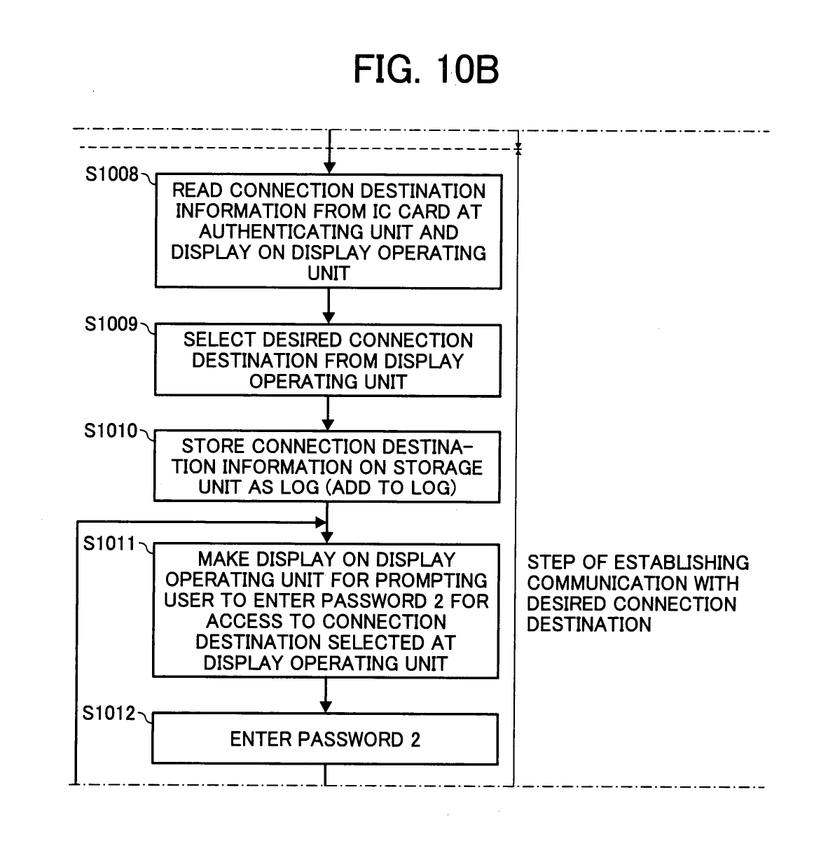

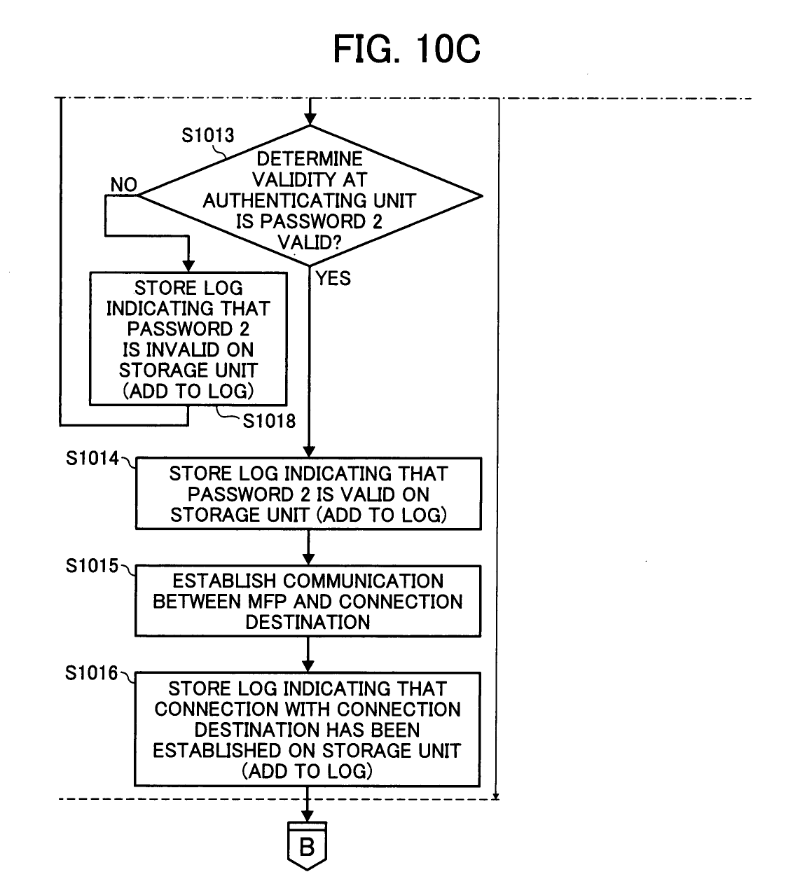

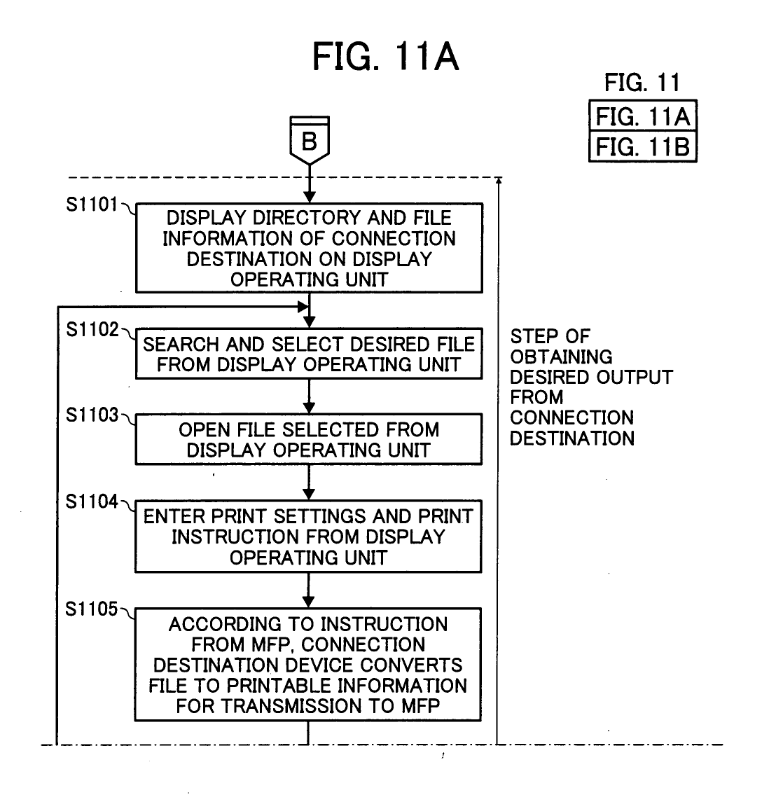

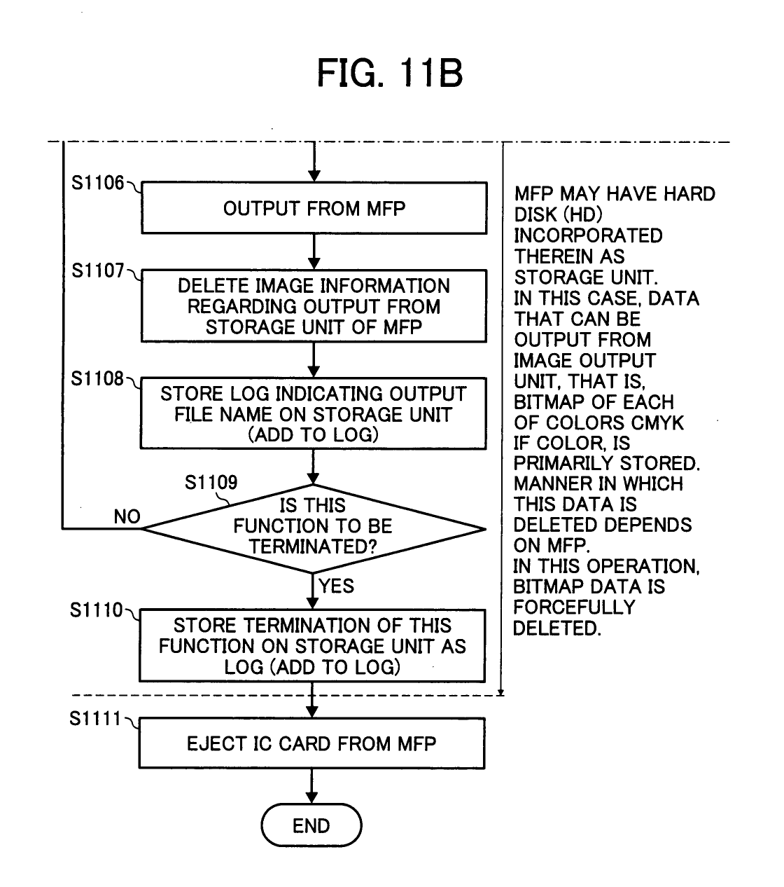

In a fifth operation example as depicted in flowcharts of FIGS. 10 and 11, with more MFPs in recent years going multifunctional, many models have a hard disk (HD) incorporated therein as a standard specification. Even if this is not the case, a hard disk can be preferably added later as an option. Reasons and merits of incorporation of an HD are as follows. When an image is formed on a paper sheet at an image forming unit, conversion is performed to obtain data corresponding to an output for one job, for example, bitmap data for each of colors of CMYK in the case of color, and the data is temporarily stored. Based on this stored data, even if the print specification is A4 in landscape orientation but the MFP has only the A4 sheets in portrait orientation left in the paper-feeding tray, the image forming unit 107 performs rotation by 90 degrees, and therefore an output is possible. After output, the job is stored according to a predetermined rule that follows the settings of the MFP. Also, with such storing, even when a paper jam occurs, an output can be produced based on the stored data after recovery without requiring a user's re-output instruction to complete the job. Also, some applications have a function of referring to, editing, and writing the bitmap data stored in the HD by using a dedicated application or the like.

After use in this operation, the confidential information is not stored in the HD of the apparatus, but such information regarding image formation is deleted after the completion of the output, thereby increasing security. Such a process flow is depicted in FIGS. 10 and 11. The basic operation is similar to that of the fourth operation example. An additional operation is step S1107 (refer to step S1107 of FIG. 11).

That is, in FIG. 10, upon selection of this function from the display operating unit of the MFP (step S1001), the IC card is inserted in the authenticating unit of the MFP to read basic information (step S1002). The basic information is then stored in the storage unit as a log (step S1003). A display of prompting the user to enter the password 1 is then made on the display operating unit (step S1004). The password 1 is then entered (step S1005).

At the authenticating unit, a validity determination is made as to whether the password in the IC card is matched with the entered password 1. If they are matched (“Yes” at step S1006), the procedure goes to the next step S1007. If they are not matched (“No” at step S1006), a log indicating that the password 1 is invalid is stored on the storage unit (such information may be added to the existing log, at step S1017), and then the procedure returns to step S1004.

A log indicating that the password 1 is valid is stored on the storage unit (such information may be added to the existing log, at step S1007). Then, connection destination information in the IC card is read at the authenticating unit, and is displayed on the display operating unit (step S1008). A desired connection destination is then selected from the display operating unit (step S1009). The selected connection destination information is then stored on the storage unit as a log (such information may be added to the existing log, at step S1010).

A display of prompting the user to enter the password 2 for access to the selected connection destination is then made on the display operating unit (step S1011). Then, the password 2 is entered (step S1012). A validity determination is then made at the authenticating unit to see whether the password 2 is valid (step S1013).

If the password 2 is valid (“Yes” at step S1013), the procedure goes to step S1014. If the password 2 is invalid (“No” at step S1013), a log indicating that the password 2 is invalid is stored on the storage unit (such information may be added to the existing log, at step S1018), and the procedure then returns to step S1011.

A log indicating that the password 2 is valid is stored on the storage unit (such information may be added to the existing log, at step S1014). Then, a communication between the MFP and the connection destination is established (step S1015). Then, a log indicating that the connection with the connection destination has been established is stored on the storage unit (such information may be added to the existing log, at step S1016).

In FIG. 11, a directory and file information of the connection destination are displayed on the display operating unit (step S1101). Then, a desired file is searched and selected from the display operating unit (step S1102). The file selected from the display operating unit is then opened (step S1103). Then, print settings and a print instruction are entered from the display operating unit (step S1104). According to the instruction from the MFP, the connection destination device converts the file to printable information for transmission to the MFP (step S1105).

The information is then output from the MFP (step S1106). The image information regarding the output is then deleted from the storage unit of the MFP (step S1107). The name of the output file is then stored on the storage unit as a log (such information may be added to the existing log, at step S1108), and then a determination of whether this function is to be terminated is made (step S109).

If this function is to be terminated (“Yes” at step S1109), the procedure goes to the next step S1110. If this function is not to be terminated (“No” at step S1109), the procedure returns to step S1102.

Termination of this function is stored on the storage unit as a log (such information may be added to the existing log, at step S1110), and then the IC card is ejected from the MFP (step S1111) for termination.

### SIXTH OPERATION EXAMPLE

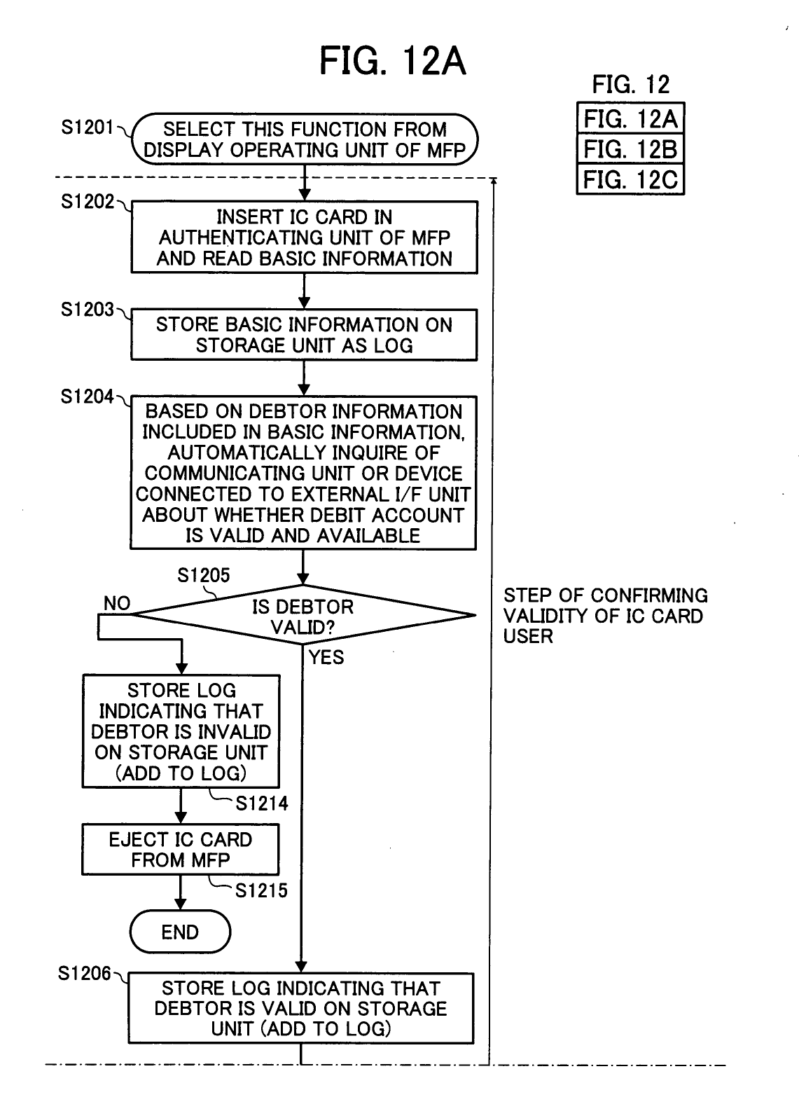

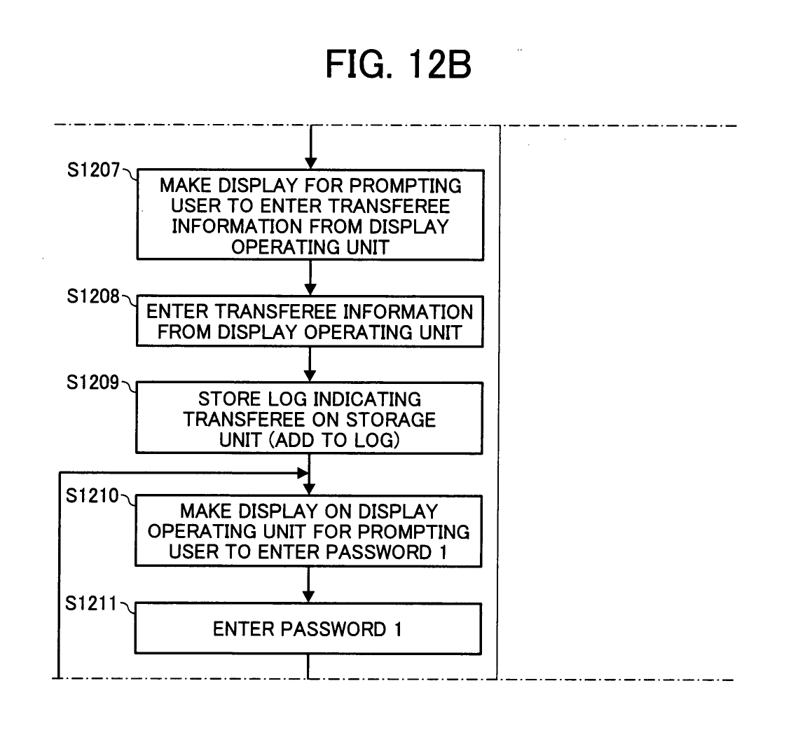

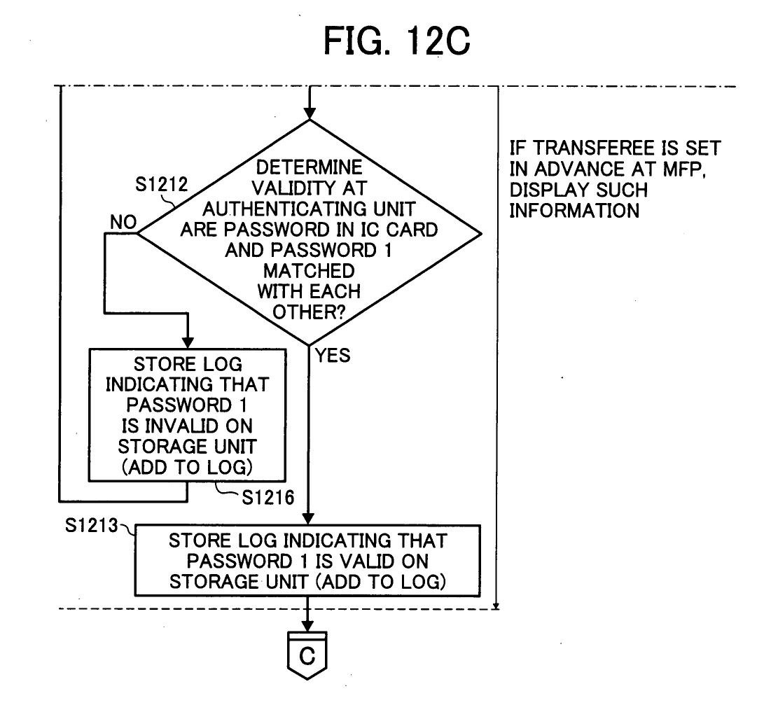

A sixth operation example is to securely perform debiting and transfer of a fee required for output and connection. As in the configuration depicted in FIG. 4, an accounting server capable of determining whether the account is valid is connected to the network, and validity is confirmed through the communicating unit 108 of the MFP. Such a flow is depicted in FIGS. 12 to 14.

The basic operation is such that steps S1204 to S1205 for authentication for secure transfer and steps S1410 to S1412 for debiting the fee are added to the fifth operation example.

That is, in FIG. 12, upon selection of this function from the display operating unit of the MFP (step S1201), the IC card is inserted in the authenticating unit of the MFP to read basic information (step S1202). The basic information is then stored in the storage unit as a log (step S1203). Based on debtor information included in the basic information, the communicating unit or a device connected to the external I/F unit is automatically inquired about whether the account is valid and available (step S1204).

Whether the debtor is valid is then determined (step S1205). If it is determined as valid (“Yes” at step S1205), the procedure goes to the next step S1206. If it is determined as invalid (“No” at step S1205), a log indicating that the debtor is invalid is stored on the storage unit (such information may be added to the existing log, at step S11214). The procedure then returns to step S1204, and also the IC card is ejected from the MFP (step S1215) for termination.

A transferee is then stored (such information may be added to the existing log, at step S1209).

A display of prompting the user to enter the password 1 is then made on the display operating unit (step S1210). The password 1 is then entered (step S1211). Then, a validity determination is made at authenticating unit as to whether the password in the IC card is matched with the entered password 1 (step S1212).

If the password in the IC card and the entered password 1 are matched with each other (“Yes” at step S1212), the procedure goes to the next step S1213. If they are not matched (“No” at step S1212), a log indicating that the password 1 is invalid is stored on the storage unit (such information may be added to the existing log, at step S1216), and then the procedure returns to step S1210.

Then, a log indicating that the password 1 is valid is stored on the storage unit (such information may be added to the existing log, at step S1213).

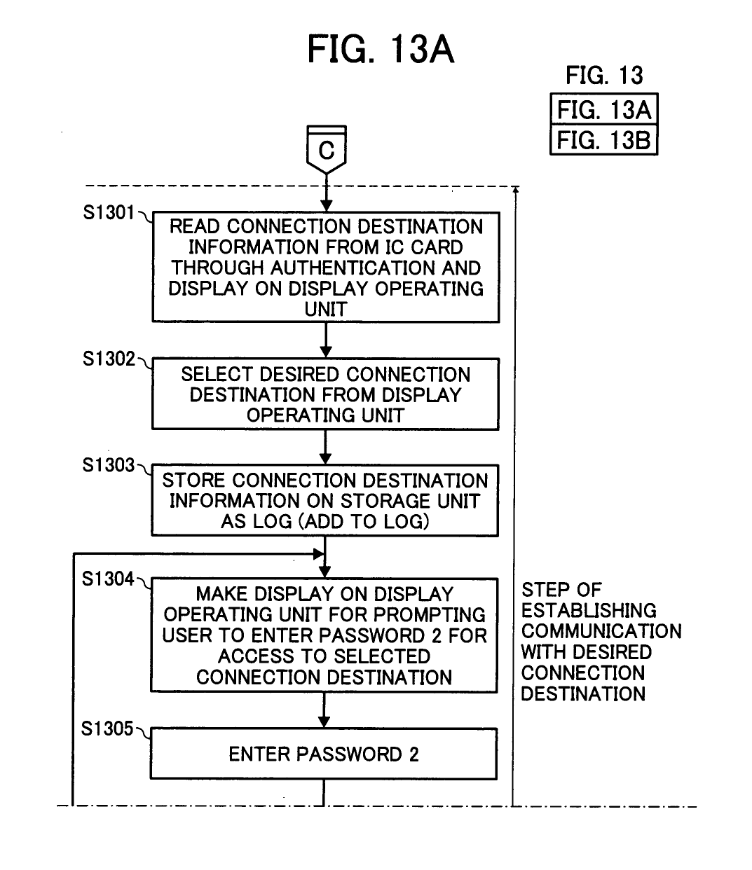

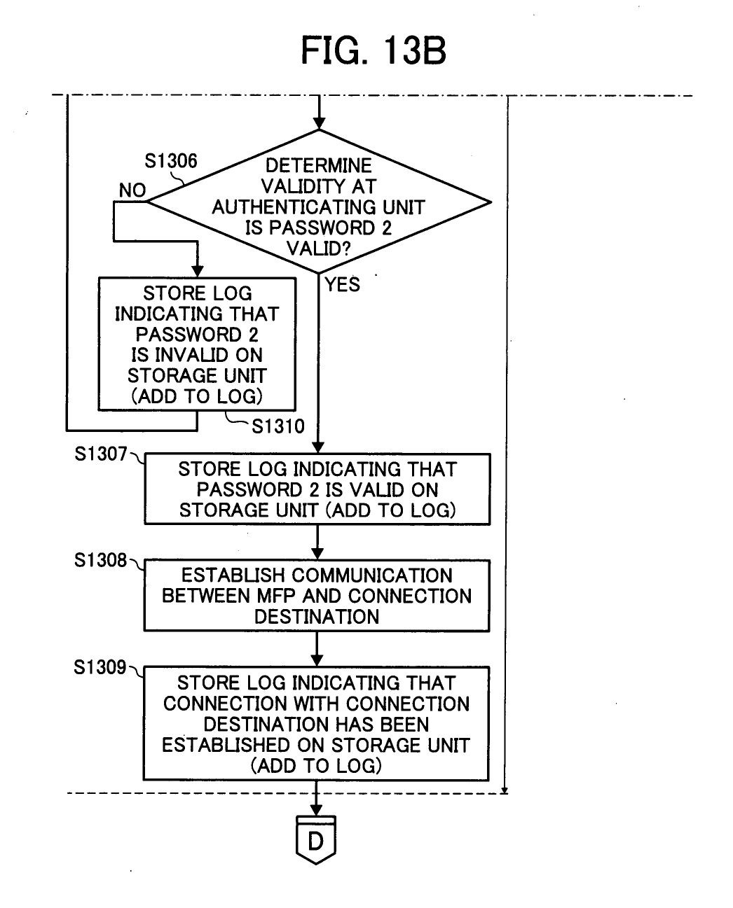

In FIG. 13, connection destination information in the IC card is then read at the authenticating unit, and is displayed on the display operating unit (step S1301). A desired connection destination is then selected from the display operating unit (step S1302). The selected connection destination information is then stored on the storage unit as a log (such information may be added to the existing log, at step S1303). A display of prompting the user to enter the password 2 for access to the selected connection destination is then made on the display operating unit (step S1304). Then, the password 2 is entered (step S1305). A validity determination is then made at the authenticating unit to see whether the password 2 is valid (step S1306).

If the password 2 is determined as valid (“Yes” at step S1306), the procedure goes to step S1307. If the password 2 is determined as invalid (“No” at step S1306), a log indicating that the password 2 is invalid is on the storage unit (such information may be added to the existing log, at step S1310), and the procedure then returns to step S1304.

A log indicating that the password 2 is valid is stored on the storage unit (such information may be added to the existing log, at step S1307). Then, a communication between the MFP and the connection destination is established (step S1308). Then, a log indicating that the connection with the connection destination has been established is stored on the storage unit (such information may be added to the existing log, at step S1309).

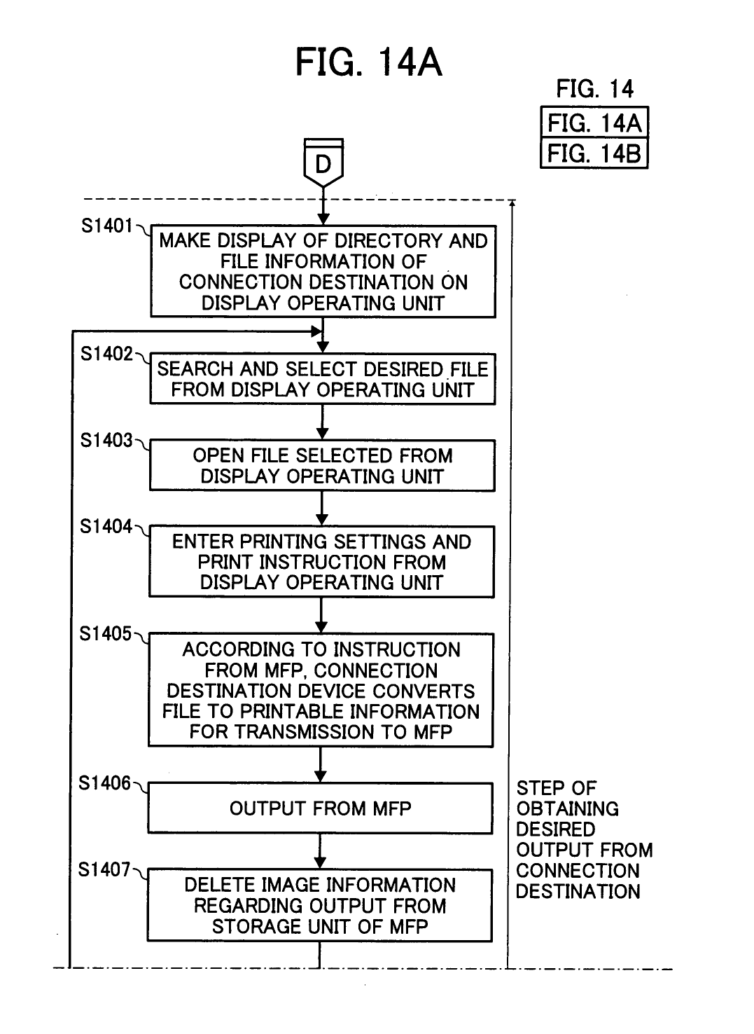

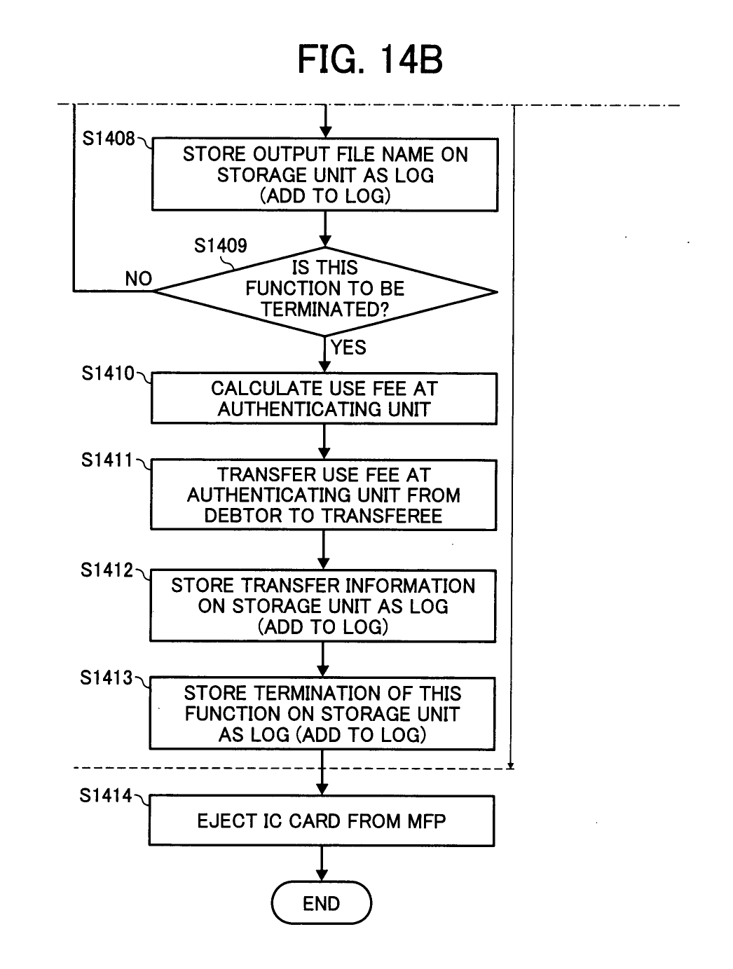

In FIG. 14, a directory and file information of the connection destination are displayed on the display operating unit (step S1401). Then, a desired file is searched and selected from the display operating unit (step S1402). The file selected from the display operating unit is then opened (step S1403). Then, print settings and a print instruction are entered from the display operating unit (step S1404). According to the instruction from the MFP, the connection destination device converts the file to printable information for transmission to the MFP (step S1405). The information is then output from the MFP (step S1406).

The image information regarding the output is then deleted from the storage unit of the MFP (step S1407). The name of the output file is then stored on the storage unit as a log (such information may be added to the existing log, at step S1408), and then a determination of whether this function is to be terminated is made (step S1409).

If this function is to be terminated (“Yes” at step S1409), the procedure goes to the next step S1410. If this function is not to be terminated (“No” at step S1409), the procedure returns to step S1402.

A use fee is then calculated at the authenticating unit (step S1410). The use fee is then transferred at the authenticating unit from the debtor to the transferee (step S1411). Then, transfer information is then stored on the storage unit as a log(such information may be added to the existing log, at step S1412). Termination of this function is then stored on the storage unit as a log(such information may be added to the existing log, at step S1413). Then, the IC card is ejected from the MFP (step S1414) for termination.

### SEVENTH OPERATION EXAMPLE

The sixth operation example is effective in a relatively high security limited environment, such as inside a company. On the other hand, when an operation of exchanging fees among different companies is performed, security has to be further secured.

To solve this problem, an accounting server of a third party independent from the company is used in place of the accounting server depicted in FIG. 4 to ensure security.

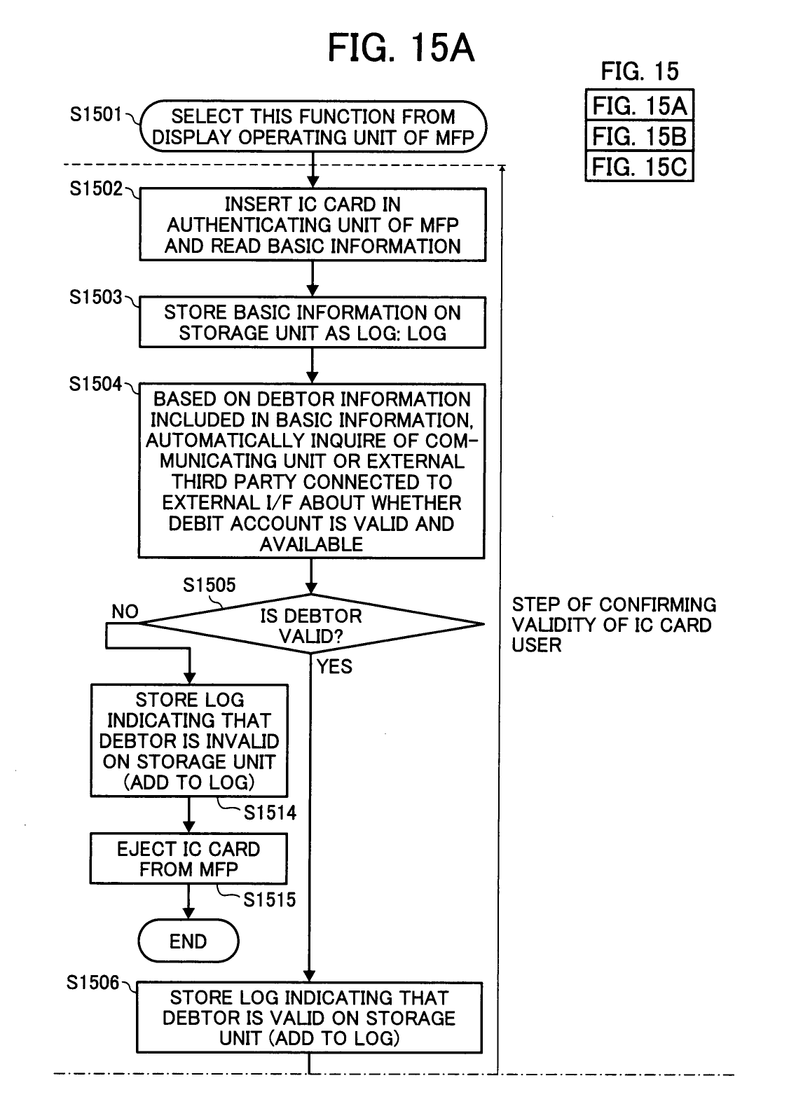

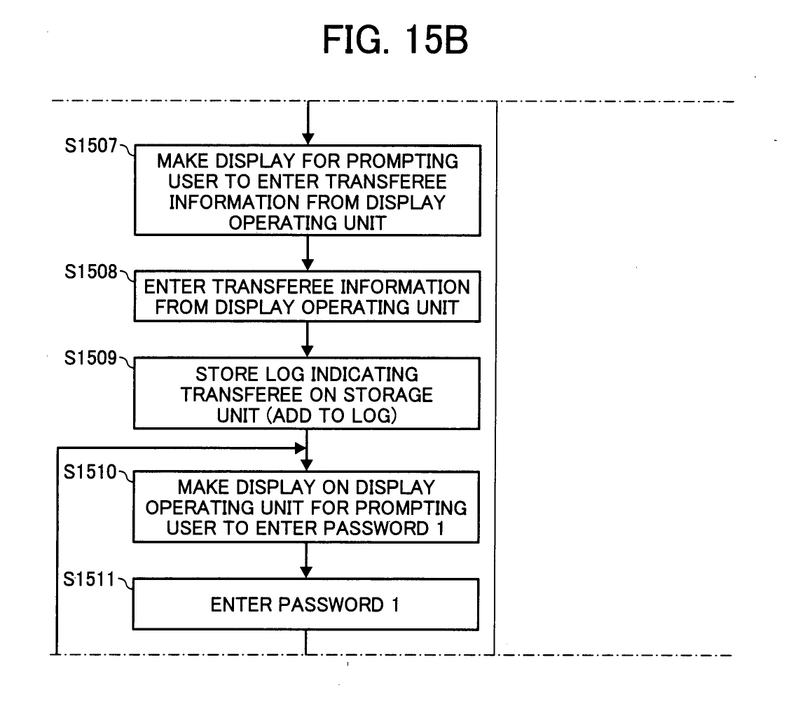

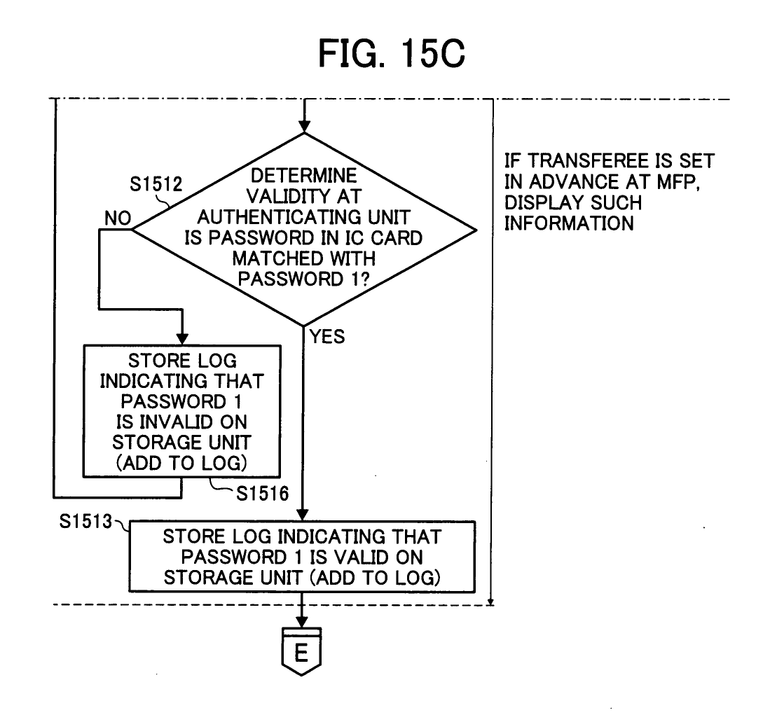

For example, a step of inquiring of an accounting server connected to each financial institution online and managed by each financial institution is added. Such a flow is depicted in FIGS. 15 to 17.

Debtor information is secured and convenient if being stored in advance in the IC card. The transferee may be similarly stored in the IC card. Here, in consideration of an output at an arbitrary place, an example is taken in which transferee information corresponding to the installed MFPs is entered.

Also, a method can be taken in which information is registered in advance in the storage unit 104 of the MFP is displayed on the display operating unit 103 to prompt the user to enter an input. In the present operation example, to further ensure security compared with the sixth embodiment, an accounting server of a third party is used to ensure security, as mentioned above. That is, in place of step S1204 in the sixth operation example, step S1504 is adopted in the present operation example.

In FIG. 15, upon selection of this function from the display operating unit of the MFP (step S1501), the IC card is inserted in the authenticating unit of the MFP to read basic information (step S1502). The basic information is then stored in the storage unit as a log (step S1503). Based on debtor information included in the basic information, the communicating unit or a device connected to the external I/F unit is automatically inquired about whether the account is valid and available (step S1504).

Whether the debtor is valid is then determined (step S1505). If it is determined as valid (“Yes” at step S1505), the procedure goes to the next step S1506. If it is determined as invalid (“No” at step S1505), a log indicating that the debtor is invalid is stored on the storage unit (such information may be added to the existing log, at step S1514). The procedure then returns to step S1504, and also the IC card is ejected from the MFP (step S1515) for termination.

A log indicating that the debtor is valid is stored on the storage unit (such information may be added to the existing log, at step S1506). Then, a display that prompts the user to enter transferee information is made from the display operating unit (step S1507). The transferee information is then entered from the display operating unit (step S1508), and a log indicating the transferee information is then stored on the storage unit (such information may be added to the existing log, at step S1509).

A display that prompts the user to enter the password 1 is then made on the display operating unit (step S1510). The password 1 is then entered (step S1511). Then, a validity determination is made as to whether the password in the IC card is matched with the entered password 1 (step S1512).

If the password in the IC card and the entered password 1 are matched with each other (“Yes” at step S1512), the procedure goes to the next step S1513. If they are not matched (“No” at step S1512), a log indicating that the password 1 is invalid is stored on the storage unit (such information may be added to the existing log, at step S1516), and then the procedure returns to step S1510.

Then, a log indicating that the password 1 is valid is stored on the storage unit (such information may be added to the existing log, at step S1513).

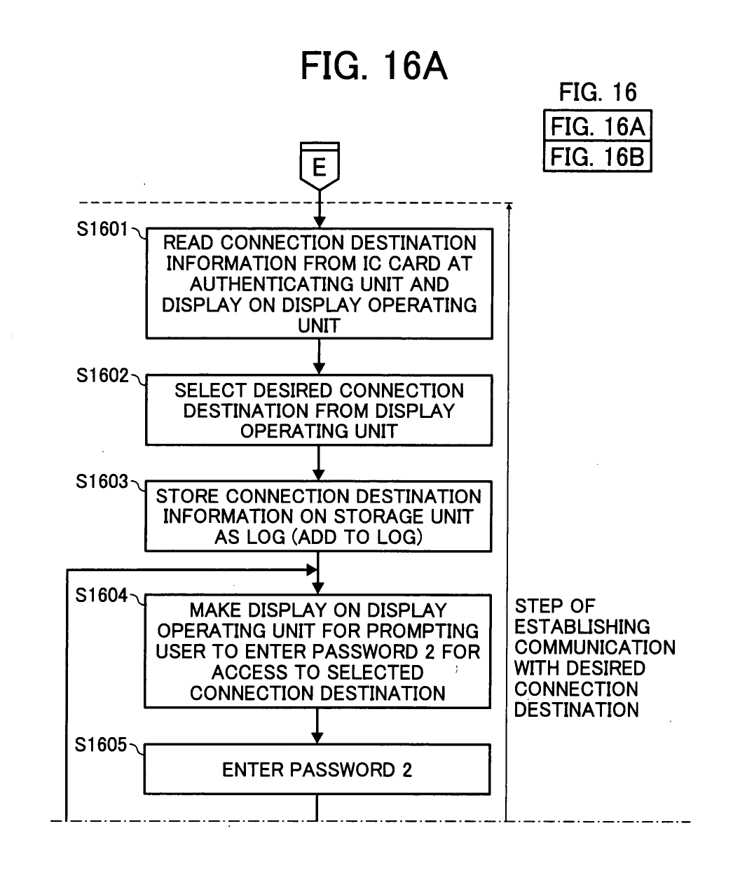

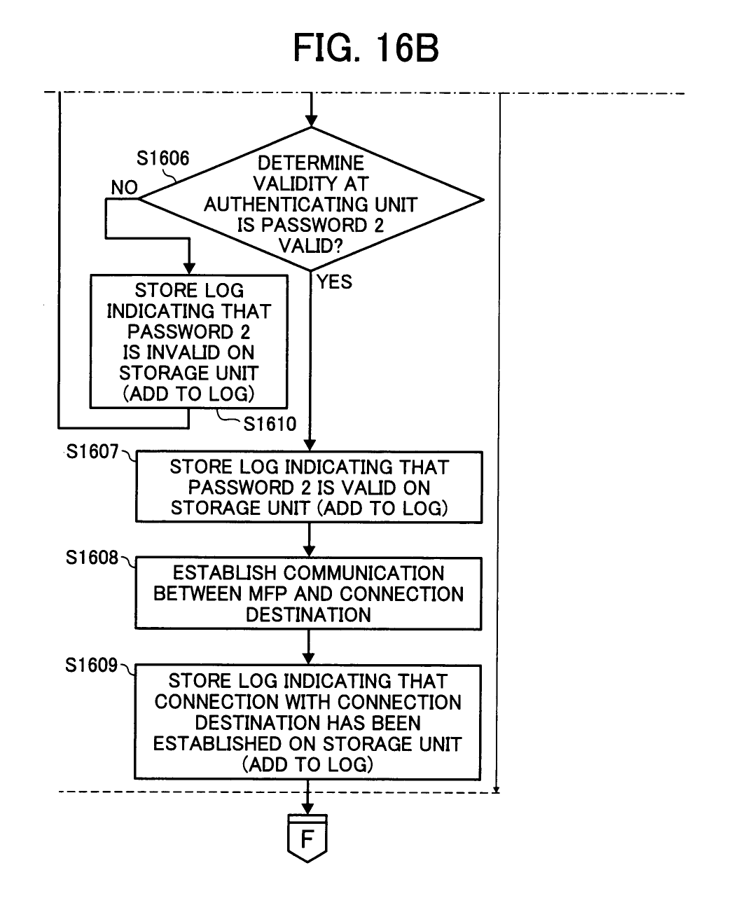

In FIG. 16, connection destination information in the IC card is then read at the authenticating unit, and is displayed on the display operating unit (step S1601). A desired connection destination is then selected from the display operating unit (step S11602). The selected connection destination information is then stored on the storage unit as a log (such information may be added to the existing log, at step S1603). A display of prompting the user to enter the password 2 for access to the selected connection destination is then made on the display operating unit (step S1604). Then, the password 2 is entered (step S1605). A validity determination is then made at the authenticating unit to see whether the password 2 is valid (step S1606).

If the password 2 is determined as valid (“Yes” at step S1606), the procedure goes to step S1607. If the password 2 is determined as invalid (“No” at step S11606), a log indicating that the password 2 is invalid is stored on the storage unit (such information may be added to the existing log, at step S1610), and the procedure then returns to step S1604.

A log indicating that the password 2 is valid is stored on the storage unit (such information may be added to the existing log, at step S1607). Then, a communication between the MFP and the connection destination is established (step S1608). Then, a log indicating that the connection with the connection destination has been established is stored on the storage unit (such information may be added to the existing log, at step S1609).

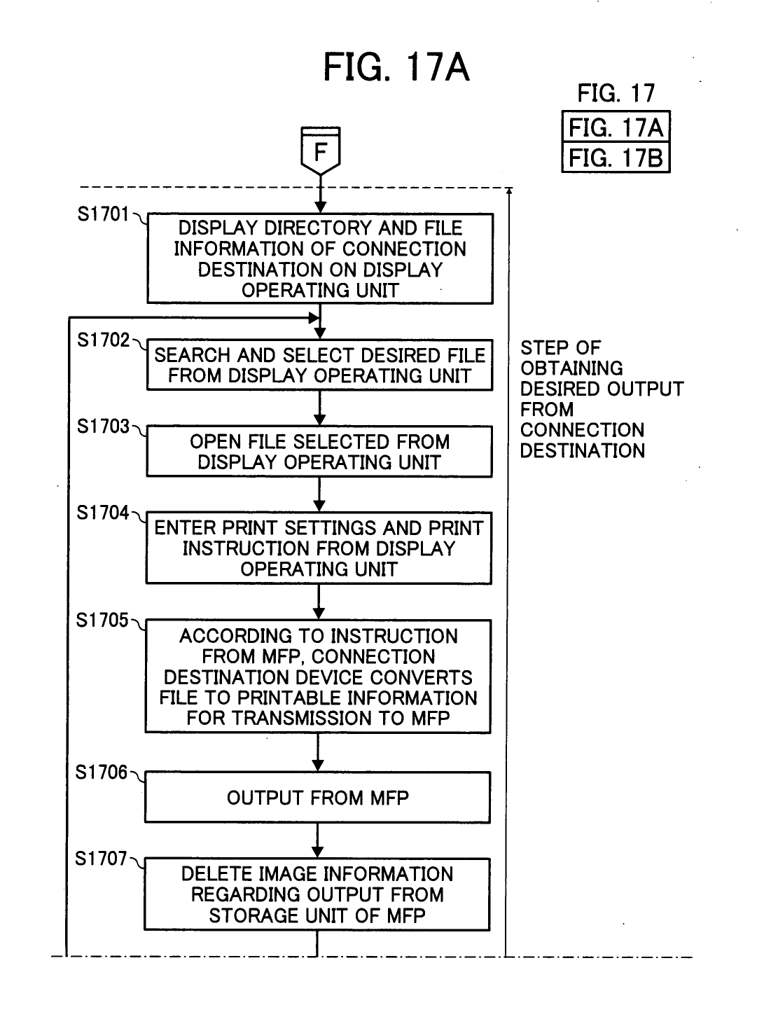

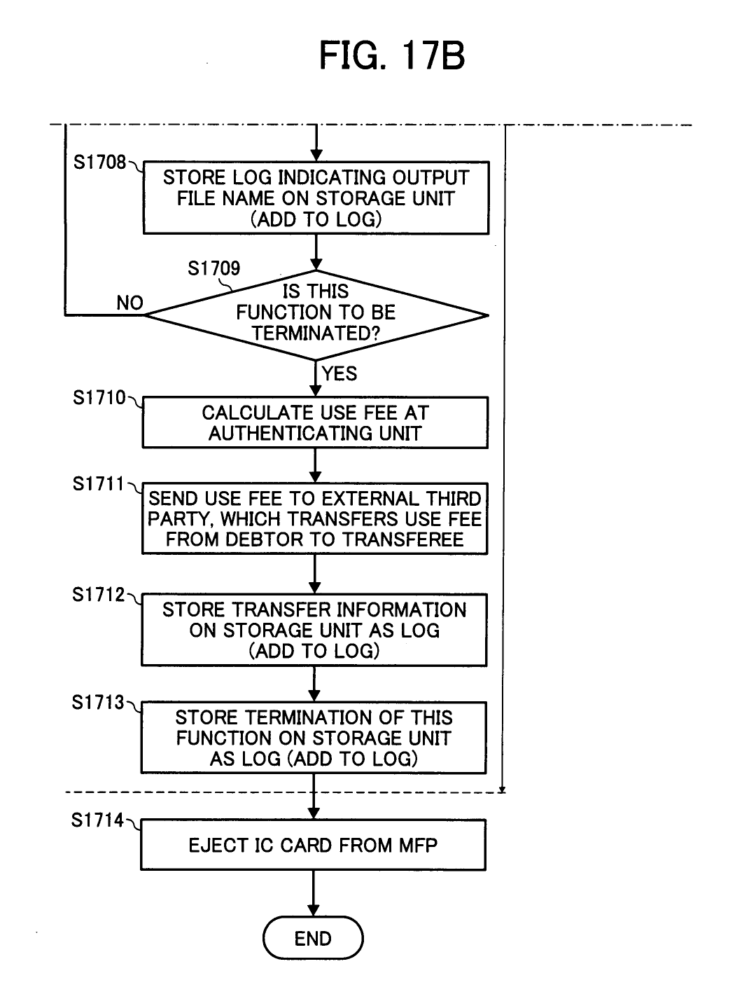

In FIG. 17, a directory and file information of the connection destination are displayed on the display operating unit (step S1701). Then, a desired file is searched and selected from the display operating unit (step S1702). The file selected from the display operating unit is then opened (step S1703). Then, print settings and a print instruction are entered from the display operating unit (step S1704). According to the instruction from the MFP, the connection destination device converts the file to printable information for transmission to the MFP (step S1705). The information is then output from the MFP (step S1706).

The image information regarding the output is then deleted from the storage unit of the MFP (step S1707). The name of the output file is then stored on the storage unit as a log (such information may be added to the existing log, at step S1708), and then a determination of whether this function is to be terminated is made (step S1709).

If this function is to be terminated (“Yes” at step S11709), the procedure goes to the next step S1410. If this function is not to be terminated (“No” at step S1709), the procedure returns to step S1702.

A use fee is then calculated at the authenticating unit (step S1710). The use fee is then transferred at the authenticating unit from the debtor to the transferee (step S1711). Then, transfer information is then stored on the storage unit as a log (such information may be added to the existing log, at step S1712). Termination of this function is then stored on the storage unit as a log (such information may be added to the existing log, at step S1713). Then, the IC card is ejected from the MFP (step S1714) for termination.

### EIGHTH OPERATION EXAMPLE

In an eighth operation example, when a fee occurs, validity of billing is a problem. That is, whether a billing amount from the fee billing side is correct or whether a transferred amount from the transferring side is correct has to be checked, and the billing amount or the transferred amount has to be prevented from manipulation. To solve this problem, in the present operation example, information associated with this operation is packed in order not be manipulated, thereby securing the master information. This information is sent by e-mail from the MFP to both parties involved in the fee. If either one of the parties manipulates the electronic document, such manipulation can be detected (in detail, refer to newly-added steps S2014 and S2015).

For securing the master information, a technology playing an important role in developing an electronic government in some countries can be adopted. In the future, for example, a home PC will be able to access to a server at a municipal office to obtain a residence certificate sent as an electronic document. As a matter of course, since a residence certificate belongs to personal information, an unauthorized request has to be prevented. Also, a government agency such as a municipal office or a person authorized to issue a residence certificate have to prevent the sent residence certificate to be falsified by the requestor. One scheme for solving these problems is electronic signature (or digital signature) using Public Key Infrastructure (PKI).

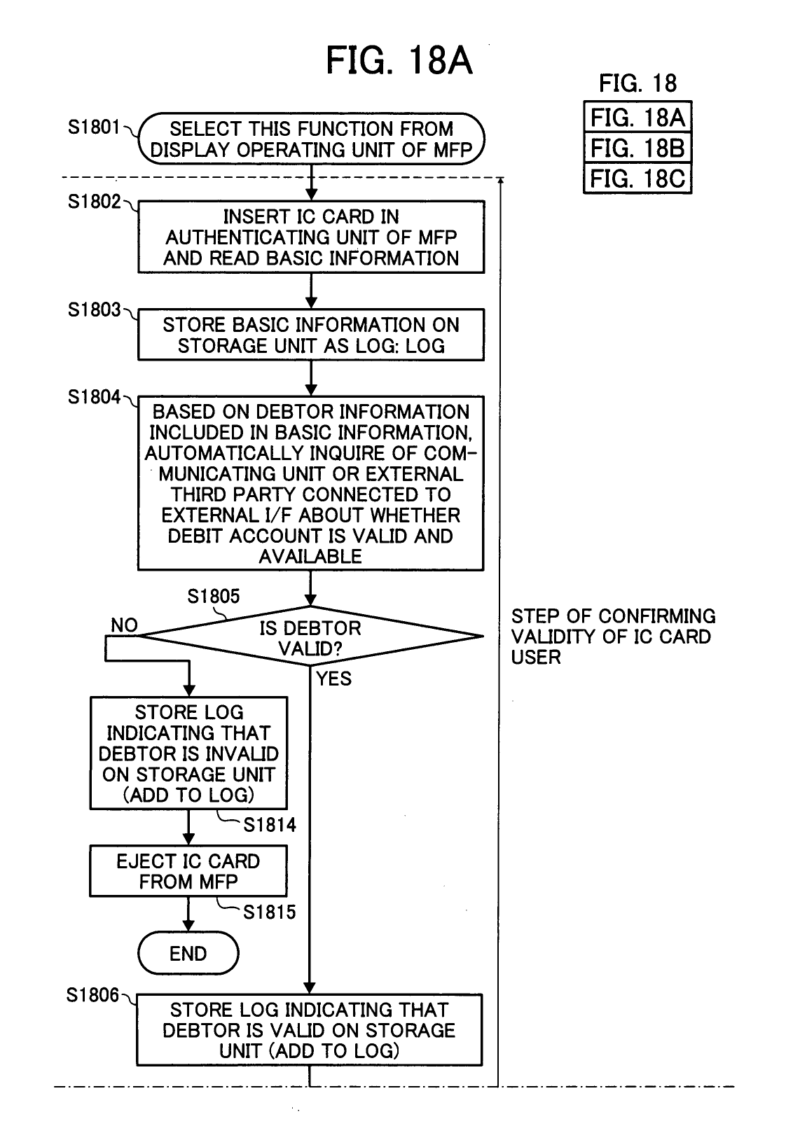

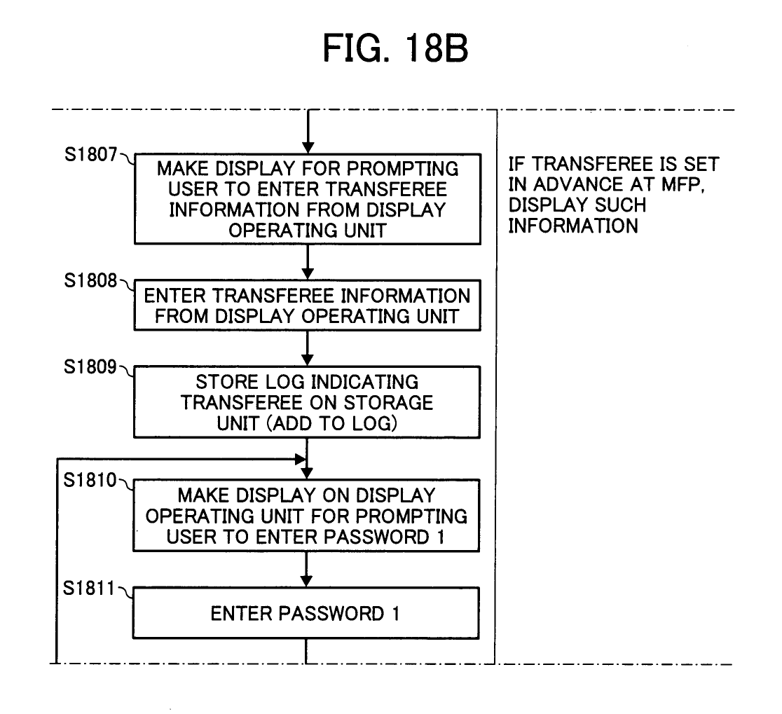

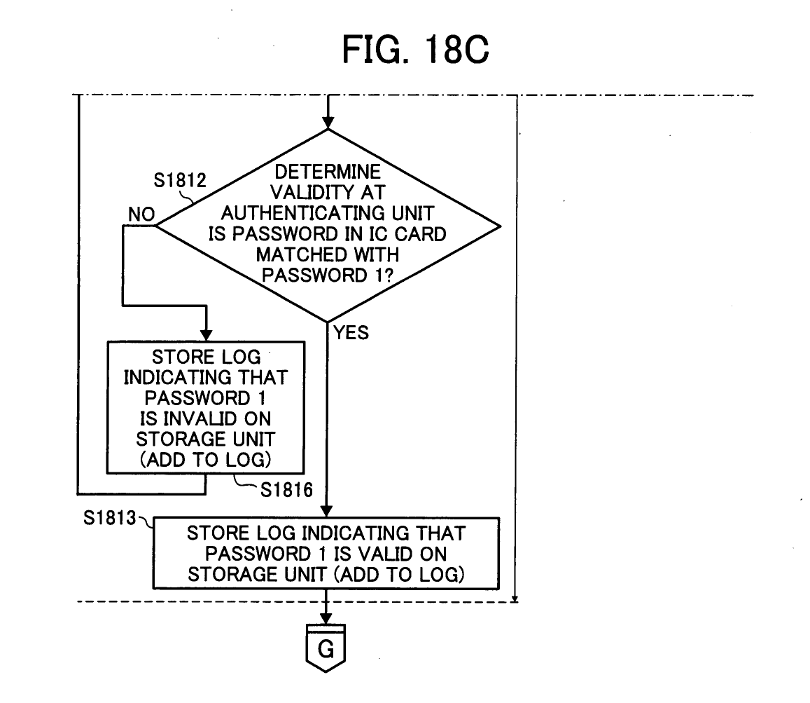

In the present operation example, such a technology (function) explained above is provided to the authenticating unit 105 of the MFP. A flow in this case is depicted in FIGS. 18 to 20. The present operation example is basically similar to the operation of the seventh operation example. As new steps, steps S2014 and S2015 are added.

That is, in FIG. 18, upon selection of this function from the display operating unit of the MFP (step S1801), the IC card is inserted in the authenticating unit of the MFP to read basic information (step S1802). The basic information is then stored in the storage unit as a log (step S1803). Based on debtor information included in the basic information, the communicating unit or a device connected to the external I/F unit is automatically inquired about whether the account is valid and available (step S1804).

Whether the debtor is valid is then determined (step S1805). If it is determined to be valid (“Yes” at step S1805), the procedure goes to the next step S1806. If it is determined to be invalid (“No” at step S1805), a log indicating that the debtor is invalid is stored on the storage unit (such information may be added to the existing log, at step S1814). The procedure then returns to step S1804, and also the IC card is ejected from the MFP (step S1815) for termination.

A log indicating that the debtor is valid is stored on the storage unit (such information may be added to the existing log, at step S1806). Then, a display of prompting the user to enter transferee information is made from the display operating unit (step S1807). The transferee information is then entered from the display operating unit (step S1808), and a log indicating the transferee information is then stored on the storage unit (such information may be added to the existing log, at step S1809).

A display of prompting the user to enter the password 1 is then made on the display operating unit (step S1810). The password 1 is then entered (step S1811). Then, a validity determination is made as to whether the password in the IC card is matched with the entered password 1 (step S1812).

If the password in the IC card and the entered password 1 are matched with each other (“Yes” at step S1812), the procedure goes to the next step S1813. If they are not matched (“No” at step S1812), a log indicating that the password 1 is invalid is stored on the storage unit (such information may be added to the existing log, at step S1816), and then the procedure returns to step S1810.

Then, a log indicating that the password 1 is valid is stored on the storage unit (such information may be added to the existing log, at step S11813).

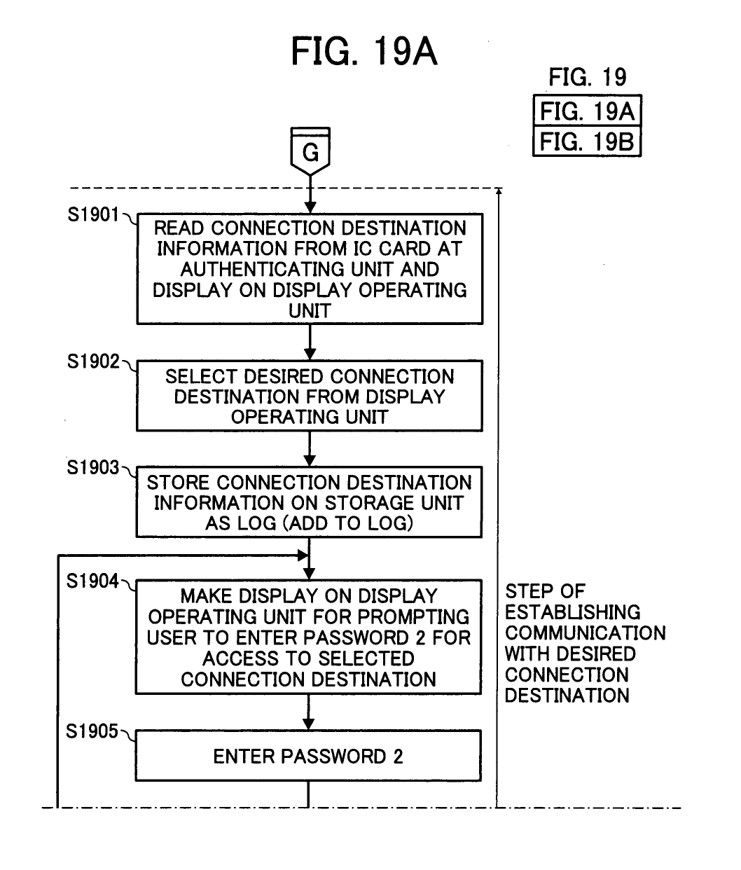

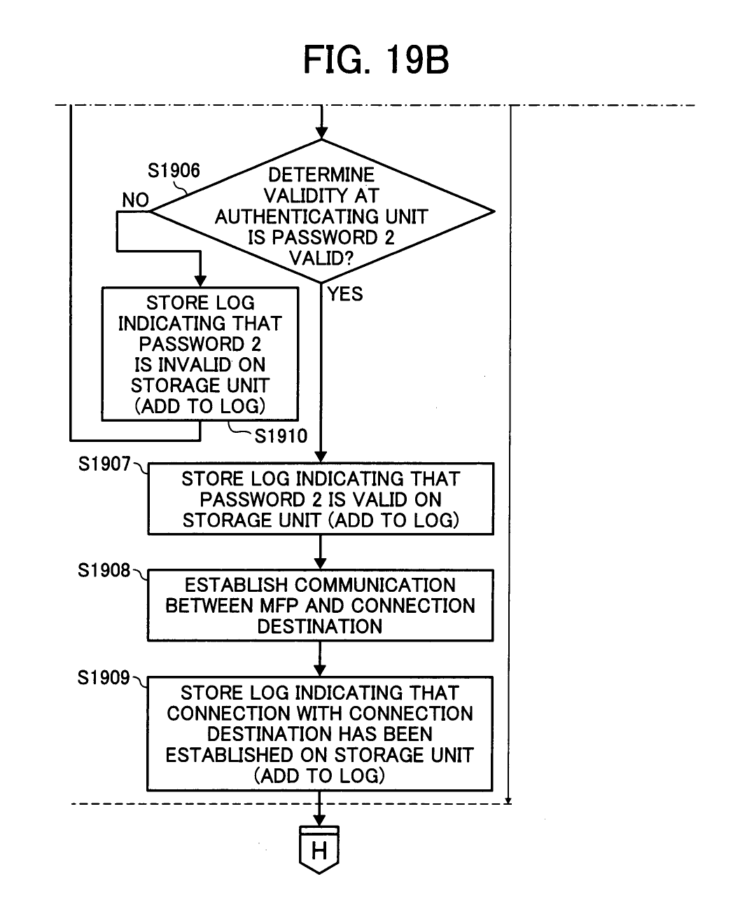

In FIG. 19, connection destination information in the IC card is then read at the authenticating unit, and is displayed on the display operating unit (step S1901). A desired connection destination is then selected from the display operating unit (step S1902). The selected connection destination information is then stored on the storage unit as a log (such information may be added to the existing log, at step S1903). A display of prompting the user to enter the password 2 for access to the selected connection destination is then made on the display operating unit (step S1904). Then, the password 2 is entered (step S1905). A validity determination is then made at the authenticating unit to determine whether the password 2 is valid (step S1906).

If the password 2 is determined as valid (“Yes” at step S1906), the procedure goes to step S1907. If the password 2 is determined as invalid (“No” at step S1906), a log indicating that the password 2 is invalid is stored on the storage unit (such information may be added to the existing log, at step S1910), and the procedure then returns to step S1904.

A log indicating that the password 2 is valid is stored on the storage unit (such information may be added to the existing log, at step S1907). Then, a communication between the MFP and the connection destination is established (step S11908). Then, a log indicating that the connection with the connection destination has been established is stored on the storage unit (such information may be added to the existing log, at step S1909).

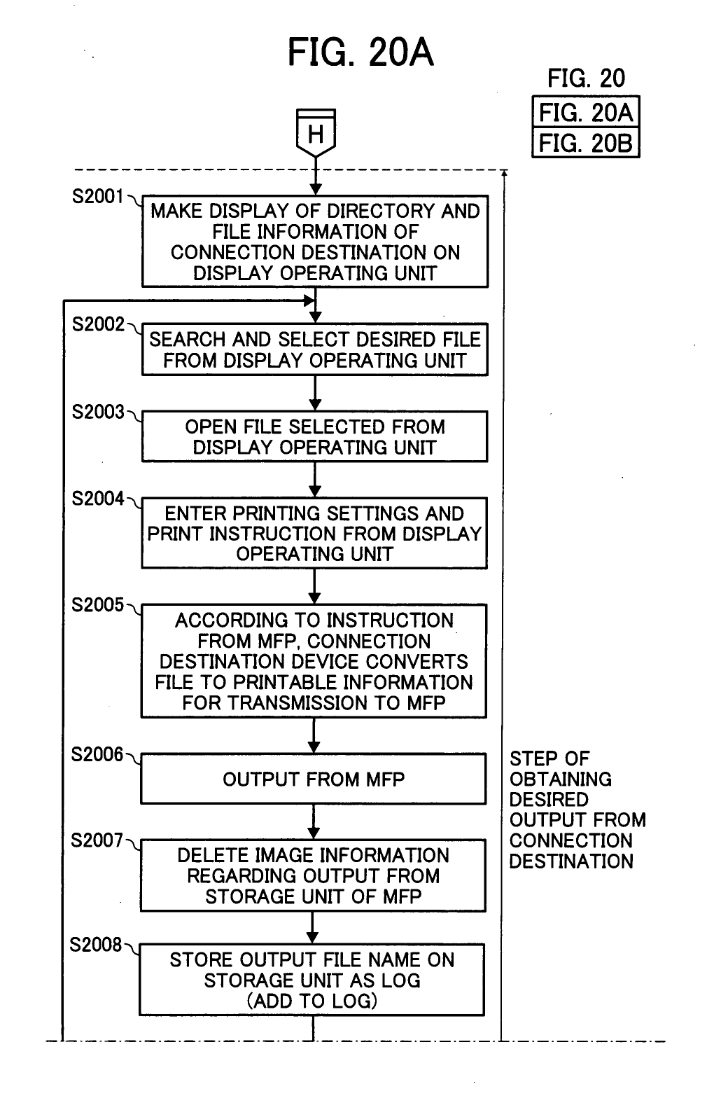

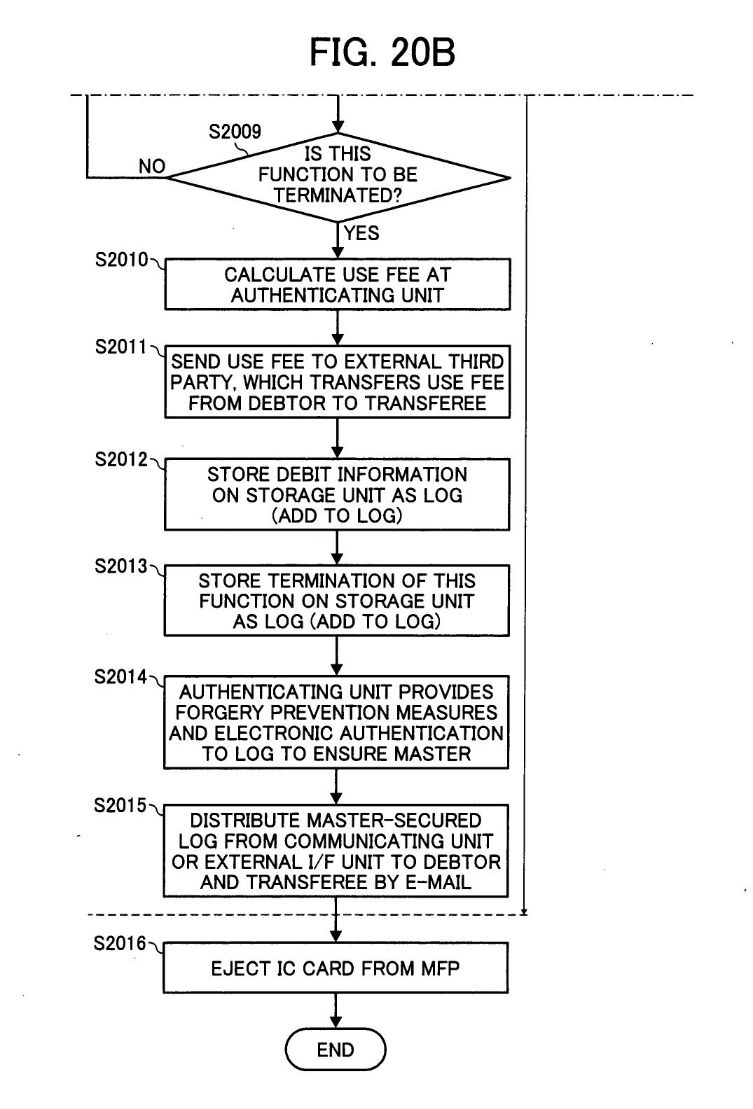

In FIG. 20, a directory and file information of the connection destination are displayed on the display operating unit (step S2001). Then, a desired file is searched and selected from the display operating unit (step S2002). The file selected from the display operating unit is then opened (step S2003). Then, print settings and a print instruction are entered from the display operating unit (step S2004). According to the instruction from the MFP, the connection destination device converts the file to printable information for transmission to the MFP (step S2005). The information is then output from the MFP (step S2006).

The image information regarding the output is then deleted from the storage unit of the MFP (step S2007). The name of the output file is then stored on the storage unit as a log (such information may be added to the existing log, at step S2008), and then a determination of whether this function is to be terminated is made (step S2009).

If this function is to be terminated (“Yes” at step S2009), the procedure goes to the next step S2010. If this function is not to be terminated (“No” at step S2009), the procedure returns to step S2002.

A use fee is then calculated at the authenticating unit (step S2010). The use fee is then transferred at the authenticating unit from the debtor to the transferee (step S2011). Then, transfer information is then stored on the storage unit as a log (such information may be added to the existing log, at step S2012). Termination of this function is then stored on the storage unit as a log (such information may be added to the existing log, at step S2013). Then, the authenticating unit provides forgery prevention measures and electronic authentication to secure master information (step S2014). The master-secured log is distributed by e-mail from the communicating unit or the external I/F unit to the debtor and the transferee (step S2015). Then, the IC card is ejected from the MFP (step S2016) for termination.

### NINTH OPERATION EXAMPLE

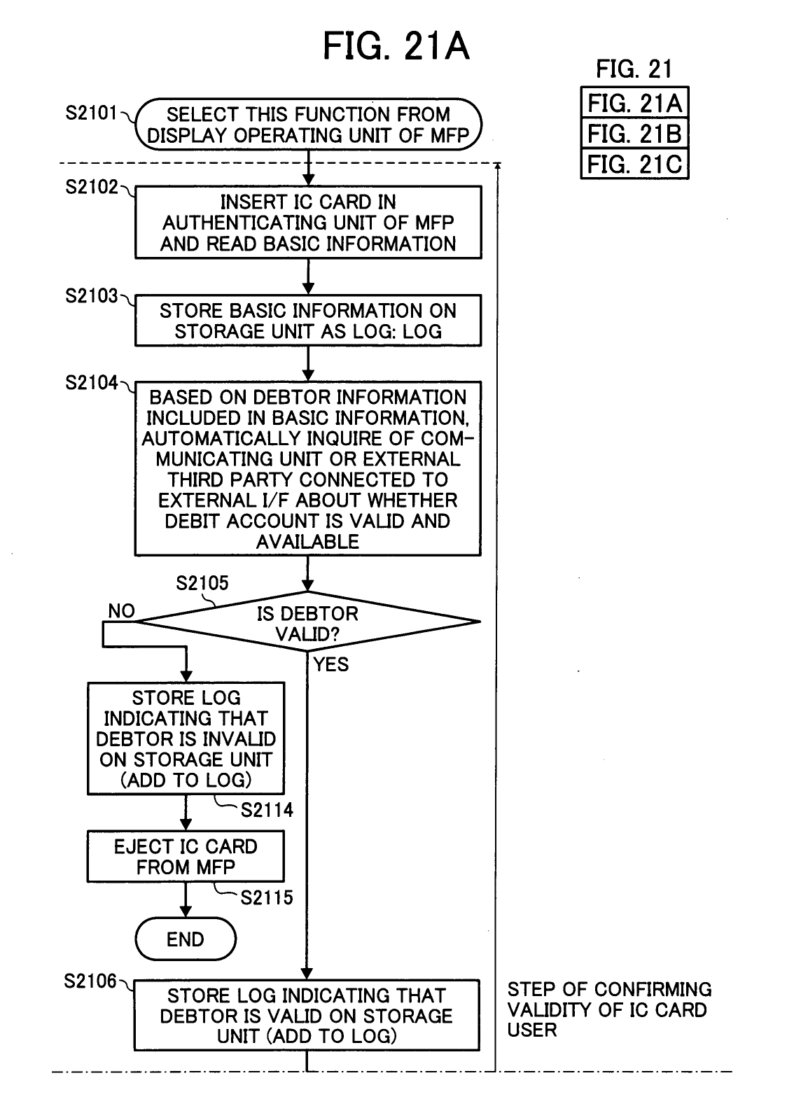

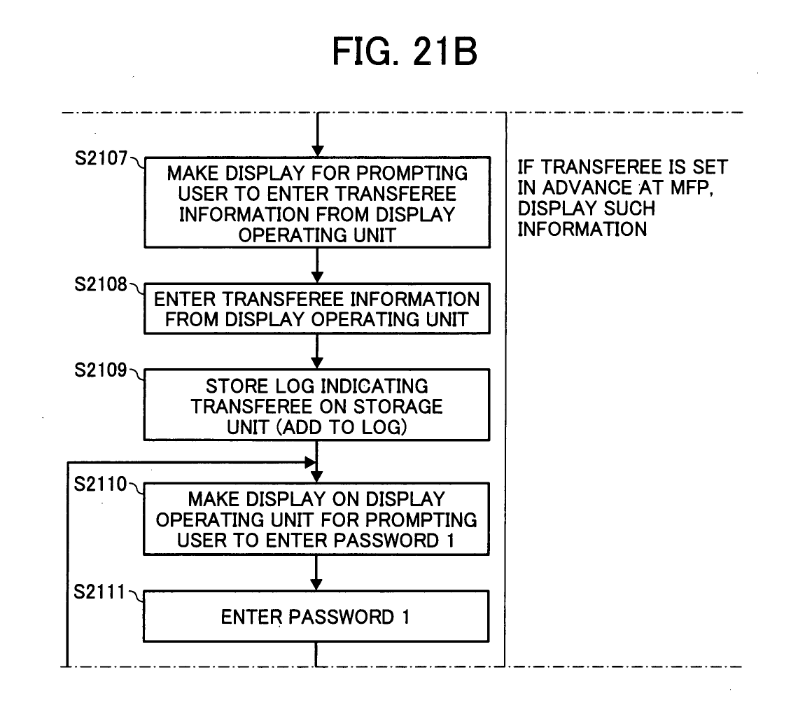

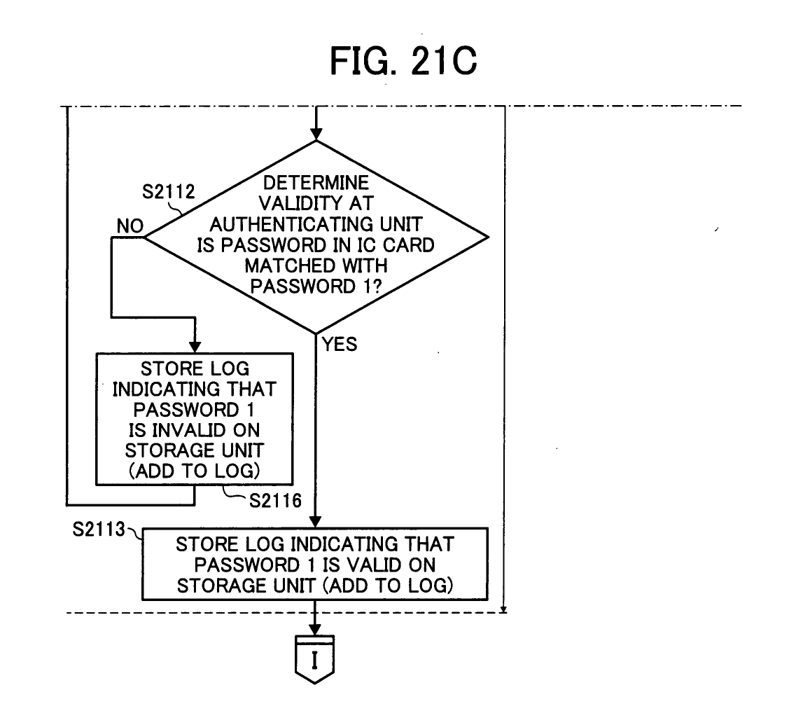

In a ninth operation example, ensuring master information in the eighth operation example is performed by a third party outside the company where the MFP is located. A flow of the present operation example is depicted in FIGS. 21 to 23. The ninth operation example is different from the eight operation example in that step S2314 is used in place of step S2014.

That is, in FIG. 21, upon selection of this function from the display operating unit of the MFP (step S2101), the IC card is inserted in the authenticating unit of the MFP to read basic information (step S2102). The basic information is then stored in the storage unit as a log (step S2103). Based on debtor information included in the basic information, the communicating unit or a device connected to the external I/F unit is automatically inquired about whether the account is valid and available (step S2104).

Whether the debtor is valid is then determined (step S2105). If it is determined as valid (“Yes” at step S2105), the procedure goes to the next step S2106. If it is determined as invalid (“No” at step S2105), a log indicating that the debtor is invalid is stored on the storage unit (such information may be added to the existing log, at step S2114). The procedure then returns to step S2104, and also the IC card is ejected from the MFP (step S2115) for termination.

A log indicating that the debtor is valid is stored on the storage unit (such information may be added to the existing log, at step S2106). Then, a display of prompting the user to enter transferee information is made from the display operating unit (step S2107). The transferee information is then entered from the display operating unit (step S2108), and a log indicating the transferee information is then stored on the storage unit (such information may be added to the existing log, at step S2109).

A display of prompting the user to enter the password 1 is then made on the display operating unit (step S2110). The password 1 is then entered (step S2111). Then, a validity determination is made as to whether the password in the IC card is matched with the entered password 1 (step S2112).

If the password in the IC card and the entered password 1 are matched with each other (“Yes” at step S2112), the procedure goes to the next step S2113. If they are not matched (“No” at step S2112), a log indicating that the password 1 is invalid is stored on the storage unit (such information may be added to the existing log, at step S2116), and then the procedure returns to step S2110.

Then, a log indicating that the password 1 is valid is stored on the storage unit (such information may be added to the existing log, at step S2113).

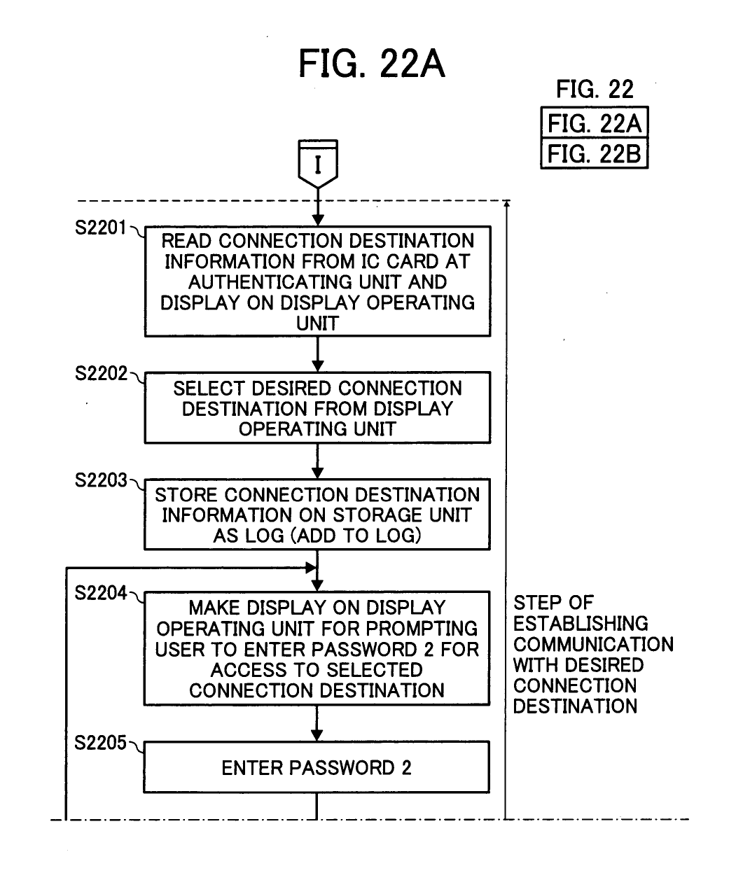

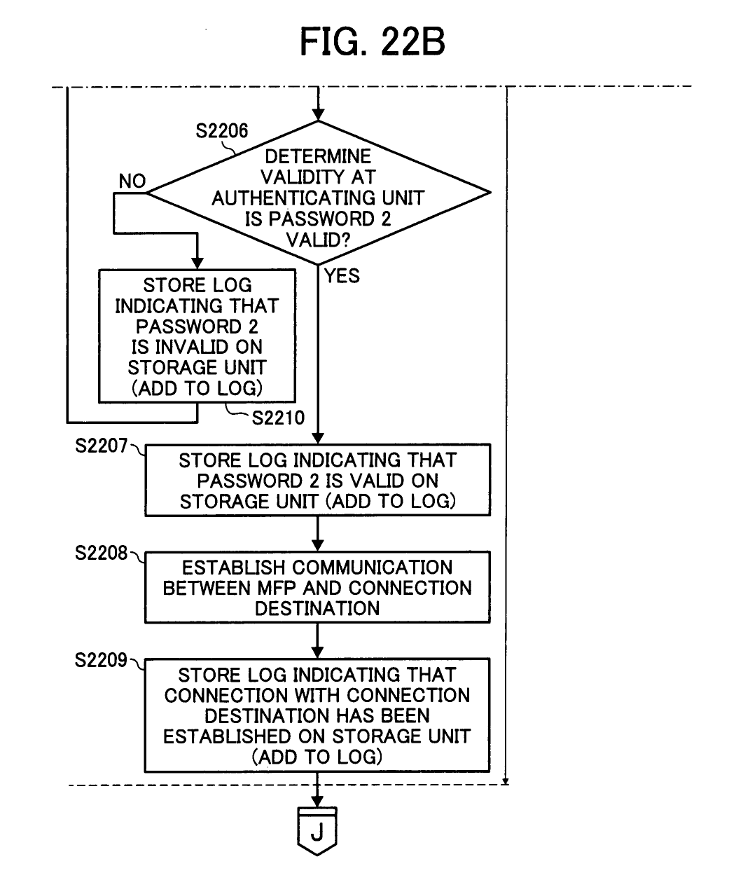

In FIG. 22, connection destination information in the IC card is then read at the authenticating unit, and is displayed on the display operating unit (step S2201). A desired connection destination is then selected from the display operating unit (step S2202). The selected connection destination information is then stored on the storage unit as a log (such information may be added to the existing log, at step S2203). A display that prompts the user to enter the password 2 for access to the selected connection destination is then made on the display operating unit (step S2204). Then, the password 2 is entered (step S2205). A validity determination is then made at the authenticating unit to determine whether the password 2 is valid (step S2206).

If the password 2 is determined to be valid (“Yes” at step S2206), the procedure goes to step S2207. If the password 2 is determined to be invalid (“No” at step S2206), a log indicating that the password 2 is invalid is stored on the storage unit (such information may be added to the existing log, at step S2210), and the procedure then returns to step S2204.

A log indicating that the password 2 is valid is stored on the storage unit (such information may be added to the existing log, at step S2207). Then, a communication between the MFP and the connection destination is established (step S2208). Then, a log indicating that the connection with the connection destination has been established is stored on the storage unit (such information may be added to the existing log, at step S2209).

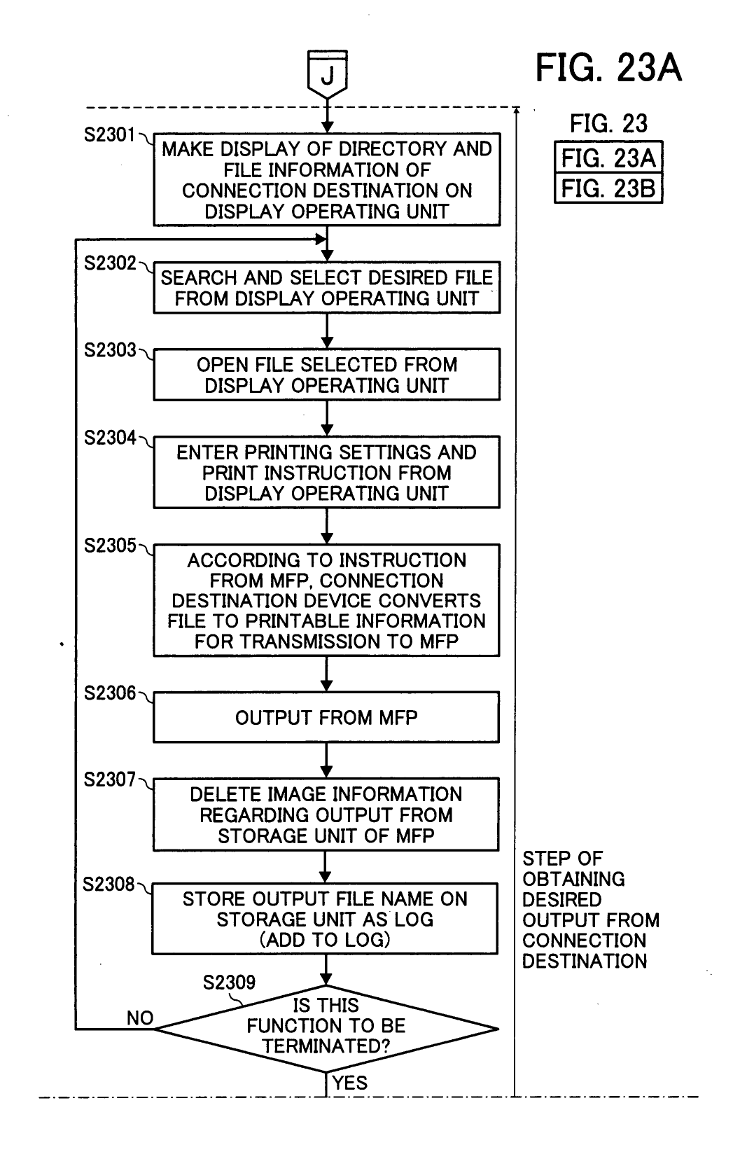

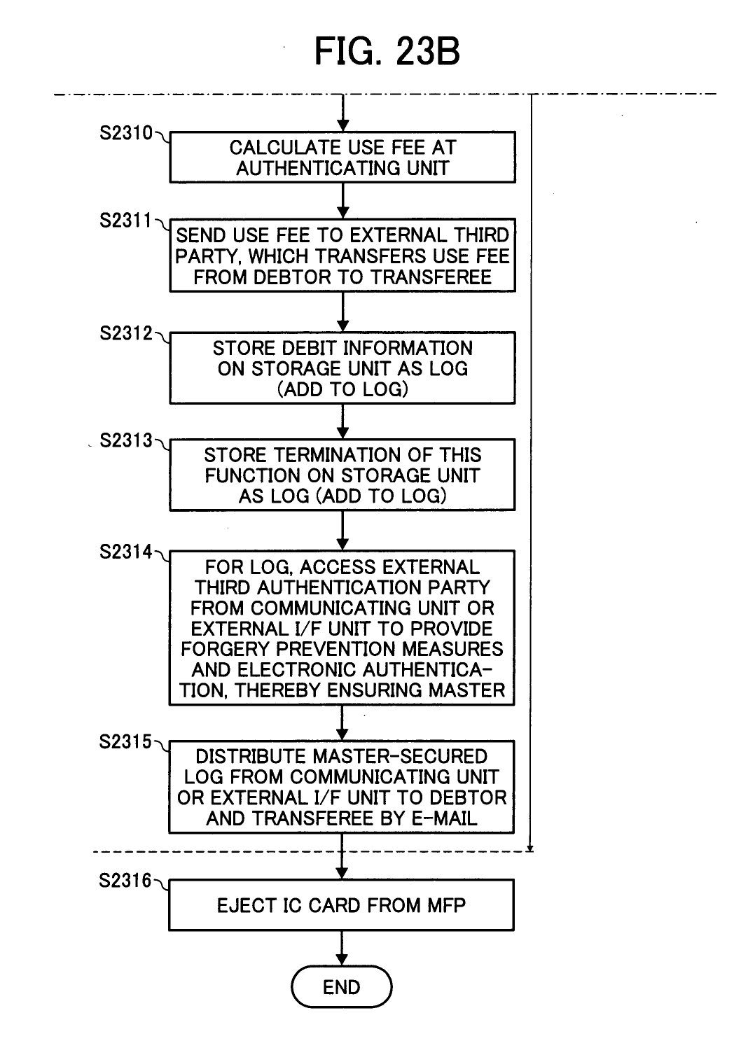

In FIG. 23, a directory and file information of the connection destination are displayed on the display operating unit (step S2301). Then, a desired file is searched and selected from the display operating unit (step S2302). The file selected from the display operating unit is then opened (step S2303). Then, print settings and a print instruction are

### TENTH OPERATION EXAMPLE

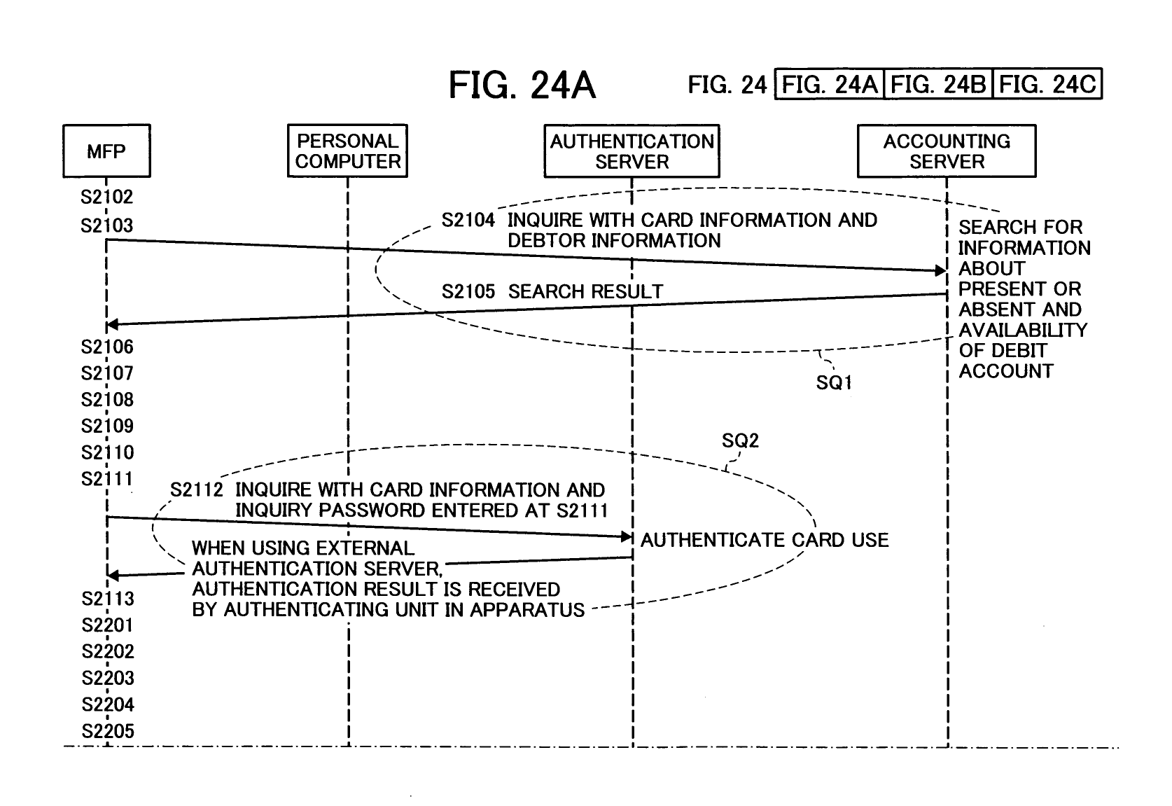

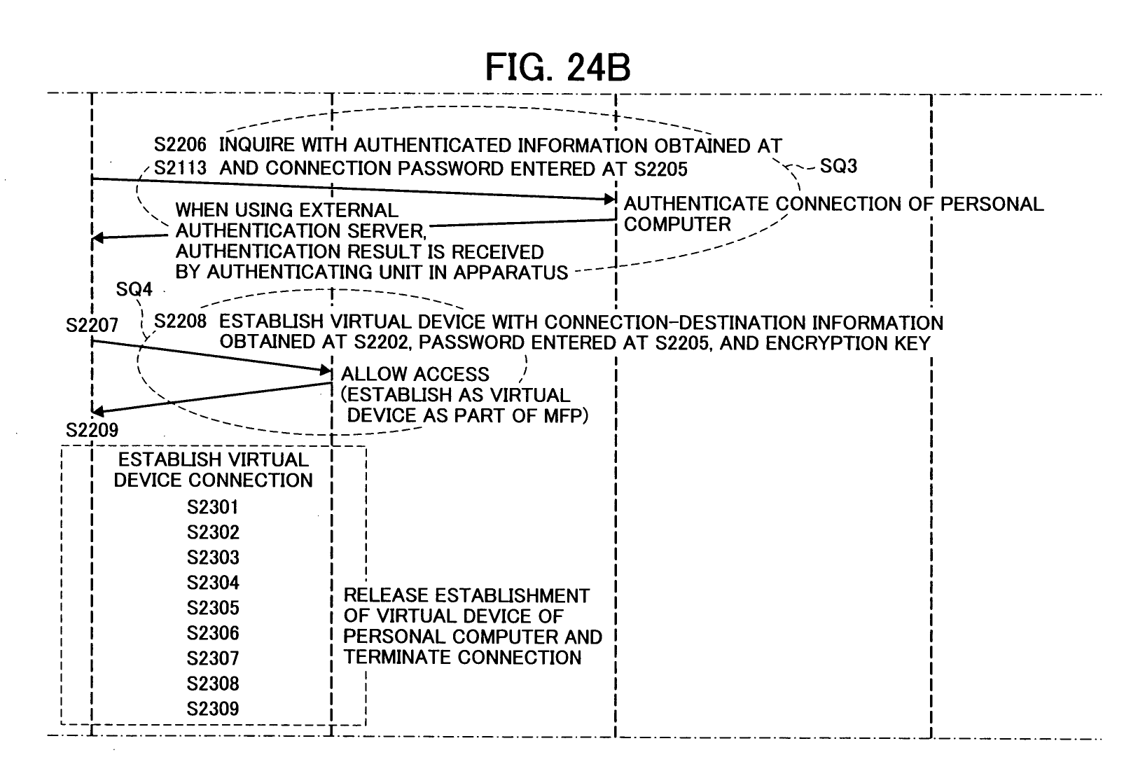

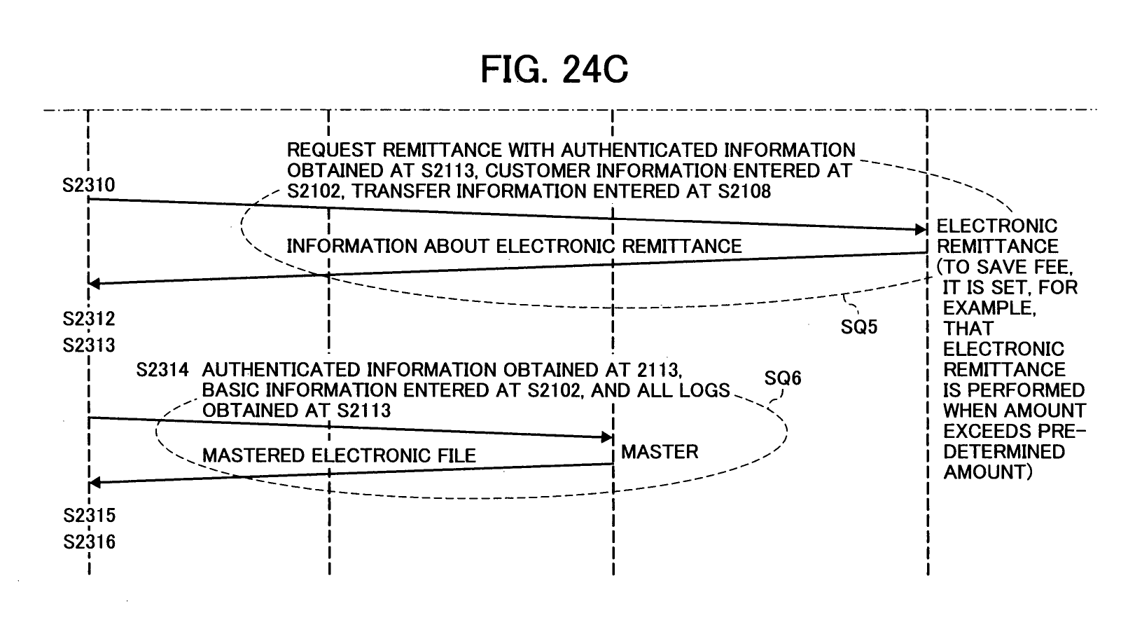

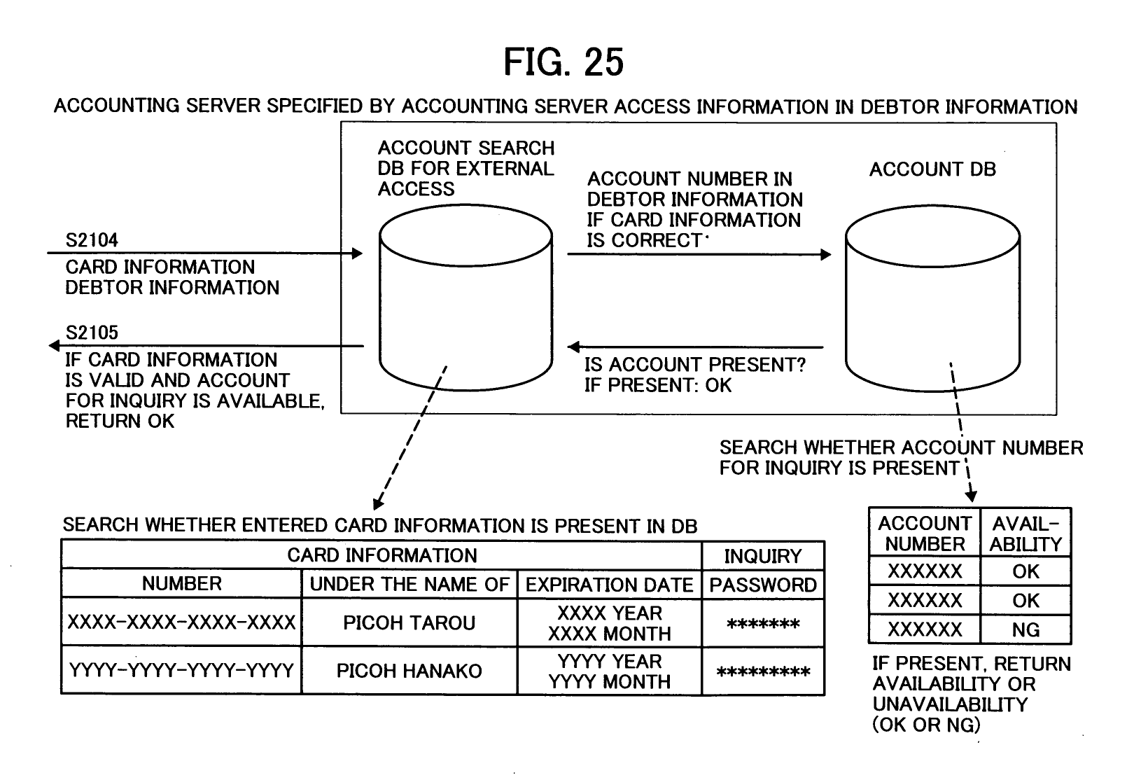

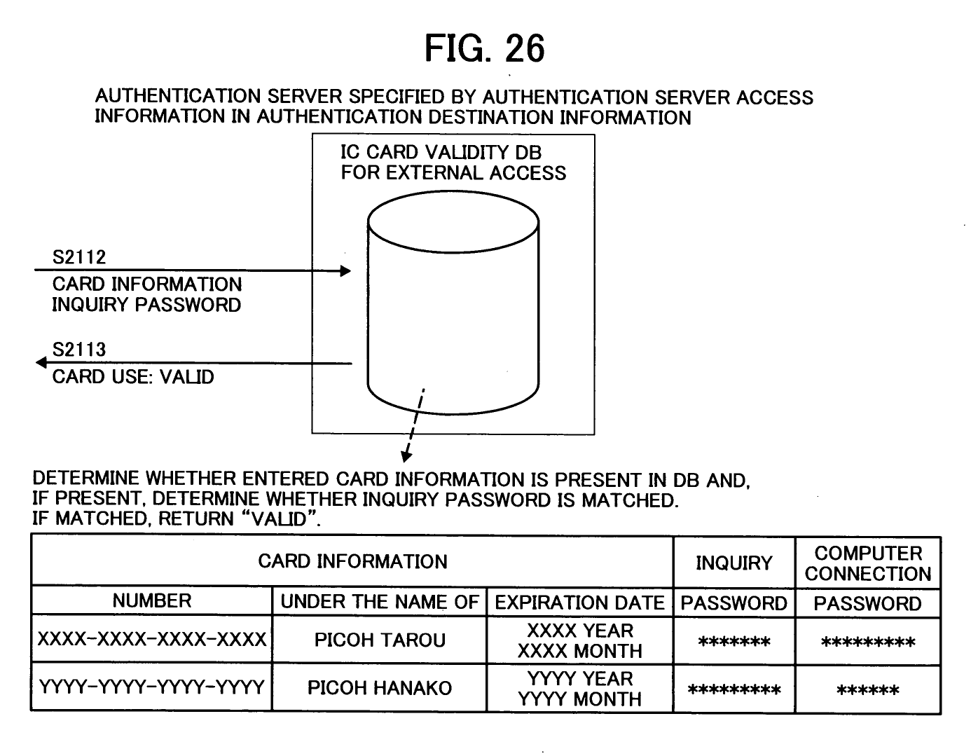

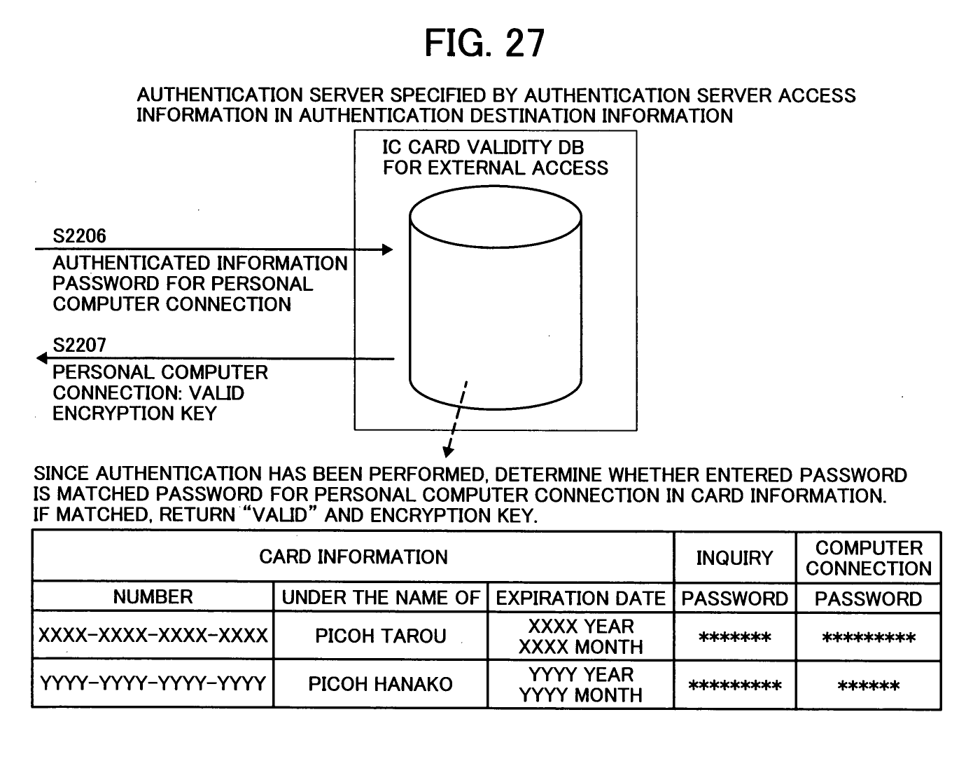

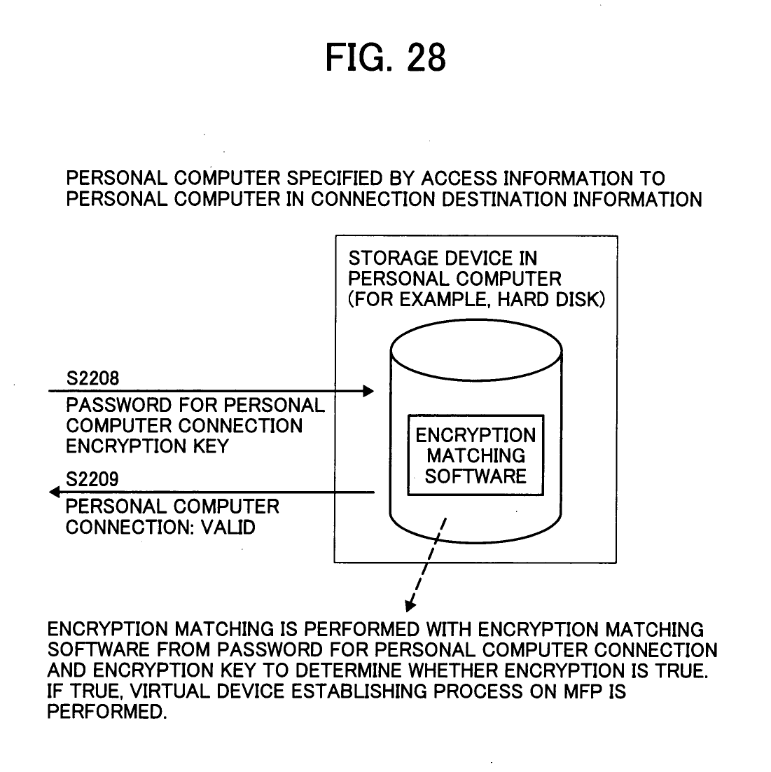

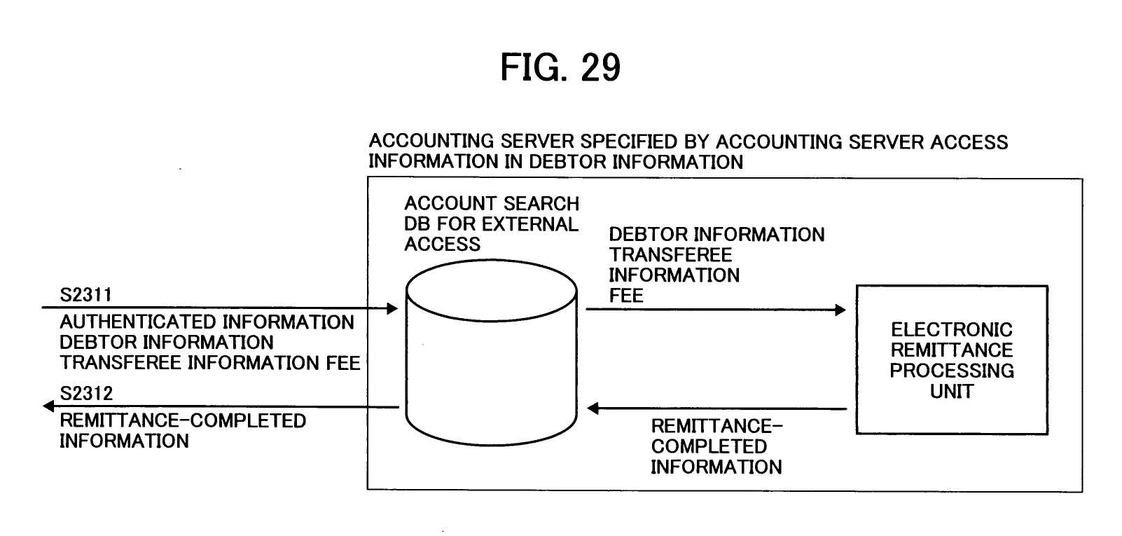

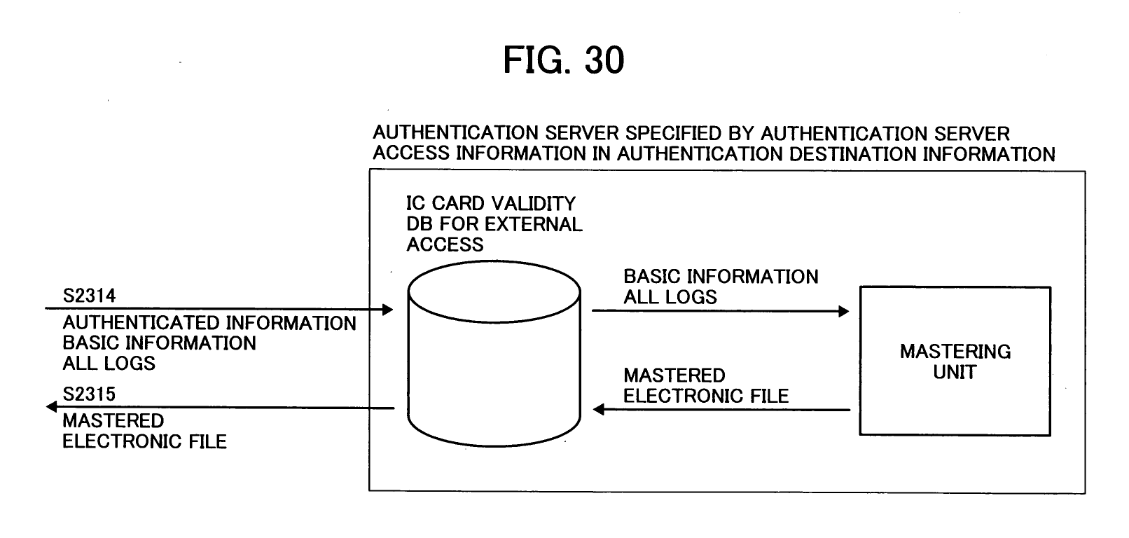

In a tenth operation example, a modification example of the ninth operation example explained by using FIGS. 21 to 23 is explained by using FIG. 24 depicting exchanges among the MFP, the PC, the authentication server, and the accounting server. Here, the operation in the MFP and the operation at the time of an unauthorized action are similar to those in the ninth operation example, and therefore are not explained herein. Also in FIG. 24, SQ1 corresponds to FIG. 25, SQ2 corresponds to FIG. 26, SQ3 corresponds to FIG. 27, SQ4 corresponds to FIG. 28, SQ5 corresponds to FIG. 29, and SQ6 corresponds to FIG. 30.

FIG. 25 is a drawing is a drawing illustrating the accounting server depicted in FIG. 24. FIG. 26 is a drawing illustrating the authentication server depicted in FIG. 24. FIG. 27 is another drawing illustrating the authentication server depicted in FIG. 24. FIG. 28 is a drawing illustrating the personal computer depicted in FIG. 24. FIG. 29 is another drawing illustrating the accounting server depicted in FIG. 24. FIG. 30 is another drawing illustrating the authentication server depicted in FIG. 24.

The MFP accesses the accounting server based on the debtor information of the basic information (*1) stored on the IC card, and then sends the card information and the debtor information required for inquiring about validity of the account to the accounting server (S2104).

*1 Basic information: Information including card information, authentication target information, and debtor information

Card information: Information such as a card number

Authentication target information: authentication server access information for access to a service provider providing reliable authentication in order to obtain authentication

Debtor information: account information for copy fee payment and accounting server entered from the display operating unit (step S2304). According to the instruction from the MFP, the connection destination device converts the file to printable information for transmission to the MFP (step S2305). The information is then output from the MFP (step S2306).

The image information regarding the output is then deleted from the storage unit of the MFP (step S2307). The name of the output file is then stored on the storage unit as a log (such information may be added to the existing log, at step S2308), and then a determination of whether this function is to be terminated is made (step S2309).

If this function is to be terminated (“Yes” at step S2309), the procedure goes to the next step S2310. If this function is not to be terminated (“No” at step S2309), the procedure returns to step S2302.

A use fee is then calculated at the authenticating unit (step S2310). The use fee is then sent to a third party outside the apparatus, and then transferred at the authenticating unit from the debtor to the transferee (step S2311). Then, transfer information is then stored on the storage unit as a log (such information may be added to the existing log, at step S2312). Termination of this function is then stored on the storage unit as a log (such information may be added to the existing log, at step S2313). Then, for the log, a third authentication party is accessed from the communicating unit or the external I/F unit to provide forgery prevention measures and electronic authentication to the log in order to secure master information (step S2314). The master-secured log is distributed by e-mail from the communicating unit or the external I/F unit to the debtor and the transferee (step S2315). Then, the IC card is ejected from the MFP (step S2316) for termination.

access information set by a company to which a card holder belongs.

In the accounting server, based on the card information and the debtor information, an account search DB for external access and an account DB in the accounting server are searched for information about whether the debtor account is present and whether the account is available. The search results are returned to the MFP (S2105) (FIG. 25). The information associated with the processes so far is concealed from the user using the MFP. If there is a problem with the debtor, a log indicating that the debtor is invalid is stored on the storage unit (S2114). With the IC card being ejected from the MFP (S2115), the user can realize that the debtor account has a problem.

Here, an example of improving security at the time of accessing the accounting server is additionally explained. In the accounting server, the card information and an inquiry password are registered in advance in the account search DB for external access as being associated with each other. The user using the MFP enters the inquiry password from the MFP. The MFP then sends the inquiry password together with the card information included in the basic information to the accounting server. If the inquiry password sent from the MFP is matched with the inquiry password corresponding to the card information registered in the account search DB for external access, the accounting server performs searching. In this manner, security of the access to the accounting server can be improved.

Also, to prevent the user using the MFP from intentionally performing an indefinite account search, the procedure is forced to jump to the process at step S2114, since it is possible to easily detect that the searching process is successively performed with the same IC card within a short period of time. With this, unauthorized use can be prevented.

In the MFP, after receiving the information about whether the debtor account is present and whether the account is available from the accounting server (the result at step S2105), S2106 to S2111 are repeated. Here, the transferee information is information about an account to which a copy fee used at the MFP is transferred, for example, information about an account of a shop where the MFP is installed for receiving a copy fee. Here, in this manner, if the transferee information is previously set as in the case where the transferee information is information about an account of a shop where the MFP is installed for receiving a copy fee, the transferee information registered in advance may be used.

Next, based on the authentication target information included in the basic information, the authentication server is accessed from the MFP, and the card information and the inquiry password entered at S2111 are sent to the authentication server (S2112). The authentication server then searches an IC card validity DB for external access included in the authentication server for the card information and the inquiry password to find whether they are matched with the card information and the inquiry password registered in advance, thereby determining whether the use of the IC card is valid. The authentication server then returns the determination result to the MFP, and the result is stored as a log (S2113) (FIG. 26).

Here, if an increase in security at the time of accessing the accounting server mentioned above is performed after this validity determination of the use of the IC card, security can be further increased, as a matter of course.

After validity of the use of the IC card is determined, the processes from S2201 to S2205 are performed at the MFP. Here, the connection destination information read from the IC card at S2201 is address information, such as an IP address or a MAC address, of a PC having stored therein information desired to be output from the MFP. Next, the authenticated information at S2113 and the password 2 (password for PC connection) entered at step S2205 are entered, and then are sent to the authentication server. Here, the authentication server may be different from the authentication server at step S2112. In that case, information and procedures similar to those required for access to the server that authenticates the validity of the IC card are also required. In this example, it is assumed that the same authentication server is used. At the authentication server, when the validity of the IC card has been authenticated, it is first determined whether the sent password for PC connection is matched with a password for PC connection registered as being associated with the same card information stored in the IC card validity DB for external access. If they are matched with each other, it is determined that the connection to the PC is valid. If the connection to the PC is valid, an encryption key issued from the authentication server is added to the information indicating that the connection to the PC is valid, and the information is then transmitted to the MFP (S2207) (FIG. 27).

If the connection to the PC is valid, the MFP accesses the PC based on the connection destination information specified at step S2202, and then sends the password for connection and the encryption key to the PC at S2205. The password and the encryption key are then passed to encryption matching software installed in the storage device of the PC to determine whether encryption is valid.

As the encryption key, for example, an RSA public key encryption scheme can be used. First, to the MFP, the authentication server provides a secret key (information encrypted with a secret key may be provided). Next, the MFP sends this secret key (or the information encrypted with the secret key) to the PC. The PC then uses a public key provided in advance from the authenticating server to check whether the sent secret key corresponds to the public key. As a result, if the secret key corresponds to the public key, it can be confirmed that the secret key has been truly provided by the authentication server.

If it is valid, a process of rendering the PC as a virtual device of the MFP is performed (with an access to the PC being restricted to one person using this process, a setting of sharing the PC from the MFP may be performed) (FIG. 28). Here, as a scheme of establishing a virtual device, a UPnP scheme can be used. With this, the PC can be handled as an external storage device of the MFP. Therefore, it is possible to access the hard disk in the PC from the display operating unit of the MFP to search for a desired electronic file and also to open the electronic file even if an application allowing a desired electronic file to be viewed is not installed in the MFP.

Here, a printing process at S2304 is additionally explained. From the PC, the manufacturer and type of the MFP, which is the connection source, cannot be known. Therefore, an exchanging process associated with printing is preferably in a form independently from the manufacturer and the type (for example, BMLinkS). If a driver of the MFP is allowed to be installed on the PC every time a connection is made from the MFP, the driver is downloaded from the MFP to the PC or an appropriate driver with MFP model information being included in the information at S2208 is downloaded through a network of the PC for installation, for example.

Next, to terminate this function, the establishment of the virtual device and the connection with the PC is cleared (S2309).

After printing from the MFP, the fee can be known. Therefore, based on the debtor information, the accounting server is accessed again for transmission of the authenticated information obtained at S2113, customer information entered at S2102, the transfer information entered at S2108, and fee information to request electronic remittance (S2311). The accounting server then performs electronic remittance based on the received various information. Here, the process may be performed for every request for electronic remittance or, if an agreement is made with the transferee in which electronic remittance is made upon reaching a predetermined amount, a commission fee or the like incurred for each small amount can be saved. Such a condition regarding electronic remittance is stored in an electronic remittance transaction DB in the accounting server, and the process along the condition described in the DB can be performed. Then, information indicating that electronic remittance is performed from the accounting server to the MFP or information indicating that remittance is made upon satisfying the predetermined condition is returned (S2312) (FIG. 29).

A series of logs associated with this process are packed (combined or collected) together, and the authentication server is accessed based on the authentication target information included in the basic information. Next, the authenticated information obtained at S2113, the basic information entered at S2102, the packed logs obtained at S2113 are sent (S2314). The authentication server performs a process of electronically mastering the sent information, and then returns the information to the MFP (FIG. 30). The MFP then sends the master-ensured electronic file to the address of the debtor and the address of the transferee.

As with the server authenticating the connection to the PC, the mastering authentication server may be a different server. In that case, the connection destination information and the condition for access have to be satisfied.

Program and Storage Medium

The image forming apparatus according to the embodiments of the present invention explained above is achieved by a program causing a computer to perform processing. Such a computer may be a general-purpose computer, such as a personal computer or a work station. However, the present invention is not restricted to the above.

With this, as long as there is a program-executable computer environment, the image forming apparatus according to the embodiments can be achieved anywhere.

Such a program may be stored in a computer-readable recording medium.

Here, examples of the recording medium include a computer-readable storage medium, such as a Compact Disc Read Only Memory (CD-ROM), a flexible disc (FD), a CD Recordable (CD-R), and a Digital Versatile Disc (DVD), and semiconductor memory, such as a Hard Disc Drive (HDD), a flash memory, a Random Access Memory (RAM), a Read Only Memory (ROM), and a Ferroelectric RAM (FeRAM).

Note that embodiments explained above are merely exemplary embodiments of the present invention. The present invention is not restricted to those explained above, and variously-modified embodiments are possible within a range not deviating from the gist of the present invention.

According to an embodiment of the present invention, with personal information and confidential information being output through a direct operation from an output device, the operator can reliably obtain such information in person.

Also, such confidential information can be retrieved from his or her own personal computer without being carried in a form of a recording medium. Therefore, problems, such as loss of a recording medium, do not occur. In addition to security at the time of establishing communication, authentication of personal identification allows more security to be ensured.

Furthermore, an exemplary operation is performed with a combination of an integrated circuit (IC) card and a password, and validity of the IC card is more ensured through an external authentication server. For example, assuming that an IC card is required for entering a company, an ID number indicating an employee on an IC card is automatically rewritten on a regular basis, thereby preventing unauthorized use of an old IC card.

Through operation, irrespectively of whether an output has been completed, logs of information about the operator and the operation process are preserved. These can be used later for tracking down some fraud.

When an output is produced through the apparatus according to the invention, image information such as CMYK (C: cyan; M: magenta; Y: yellow; and K: black) bitmap data is completely deleted from a hard disk (HD) to ensure security. However, logs are left.

Assuming development into convenience stores and net cafes, if a billing target is expressly stated, a use fee can be deducted from that billing target. However, authenticity of the existence of the billing target and whether the fee can be actually deducted has to be ensured. With establishment of validity, a secure output can be produced.

By using a third party with established security, money security can be further ensured.

To prevent unauthorized billing and requests for fees, an e-mail having incorporated therein a measure of authenticating master history information regarding the fee is sent to both parties involved in credit and debit, thereby preventing troubles associated with fees.

Furthermore, master authenticity is provided by a third party, thereby ensuring more security.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a communicating unit to establish communication with a user device selected as a connection destination;
a selection input unit to provide a selection or input for establishing security of communication with the user device as the connection destination through the communicating unit; and
an operating unit to enter an output request from the user device with security established and output information from the user device, determine whether the output request from the user device with security established is valid, and operate the output information according to the output request from the user device with security established when the output request is valid.

2. The image forming apparatus according to claim 1, further comprising an authentication establishing unit to establish validity or invalidity of a medium storing authentication information including an IC card or a credit card under a user-related name, the authentication establishing unit determining whether the medium storing the authentication information is allowed based on information associated with authentication of the medium storing the authentication information.

3. The image forming apparatus according to claim 2, further comprising an obtaining unit to obtain matching information from a device connected through the communicating unit, wherein the authentication establishing unit determines whether the medium is allowed based on information associated with the authentication of the medium storing the authentication information.

4. The image forming apparatus according to claim 1, further comprising a storage unit to store a log with the device for each state of access with the device.

5. The image forming apparatus according to claim 1, further comprising a deleting unit to delete the output information completely output upon an output request from the device.

6. The image forming apparatus according to claim 2, wherein the information associated with the authentication of the medium storing the authentication information includes payee information about a payee of a fee for use for output, and
the image forming apparatus further comprises:
a verifying unit to verify security of a user as a billing target for payment;
a payee input unit to enter the payee information when the medium storing the authentication information is verified by the verifying unit; and
a payment receiving unit to receive payment from the payee.

7. The image forming apparatus according to claim 2, further comprising:
a transmitting unit to transmit payee information included for output to a verifying unit outside of the apparatus to verify security of a user as a billing target for payment; and
a controlling unit to receive the payee information from an input unit when the medium storing the authentication information is verified by a verifying unit and transmits the payee information to a payment receiving unit for control such that payment is received from the payee.

8. The image forming apparatus according to claim 6, further comprising:
an assurance reporting unit to report, to an ensuring unit to ensure authenticity or non-authenticity of the output information, fee information incurred from an image output and user information associated with image output; and
a sending unit to send an e-mail to both of the billing target and the payee of the fee associated with the ensured information obtained from the ensuring unit via the assurance reporting unit.

9. The image forming apparatus according to claim 8, wherein the ensuring unit to ensure authenticity or non-authenticity of the information is a third party, and
the image forming apparatus further comprises a unit to cause the third party to determine whether the information has authenticity.

10. An image forming method comprising:
establishing communication with a user device selected as a connection destination;
selecting or receiving input for establishing security of communication with the user device as the connection destination; and
entering an output request from the user device with security established and output information from the user device, determining whether the output request from the user device with security established is valid, and operating the output information according to the output request from the user device with security established when the output request is valid.

11. The image forming method according to claim 10, further comprising establishing validity or invalidity of a medium storing authentication information including an IC card or a credit card under a user-related name, wherein the establishing validity or invalidity of the medium includes determining whether the medium storing the authentication information is allowed based on information associated with authentication of the medium storing the authentication information.

12. The image forming method according to claim 11, further comprising obtaining matching information from a device connected through the communicating unit, wherein the establishing the validity or invalidity of the medium includes determining whether the medium is allowed based on information associated with the authentication of the medium storing the authentication information.

13. The image forming method according to claim 10, further comprising storing in a storage device a log with the device for each state of access with the device.

14. The image forming method according to claim 10, further comprising deleting the output information completely output upon an output request from the device.

15. The image forming method according to claim 11, wherein the information associated with the authentication of the medium storing the authentication information includes payee information about a payee of a fee for use for output, and
the image forming method further comprises:
verifying security of a user as a billing target for payment;
entering the payee information when the medium storing the authentication information is verified at the verifying; and
receiving payment from the payee.

16. The image forming method according to claim 11, further comprising:
transmitting payee information included for output to a verifying unit outside of the apparatus to verify security of a user as a billing target for payment; and
receiving the payee information from an input unit when the medium storing the authentication information is verified at a verifying unit and transmitting the payee information to a payment receiving unit for control such that payment is received from the payee.

17. The image forming method according to claim 15, further comprising:
reporting, to an ensuring unit that ensures authenticity or non-authenticity of the output information, fee information incurred from an image output and user information associated with image output; and
sending an e-mail to both of the billing target and the payee of the fee associated with the ensured information obtained from the ensuring unit at the reporting.

18. The image forming method according to claim 17, wherein the ensuring unit to ensure authenticity or non-authenticity of the information is a third party, and
the image forming method further comprises causing the third party to determine whether the information has authenticity.

19. A computer program product to cause a computer to execute:
establishing communication with a user device selected as a connection destination;
selecting or receiving input for establishing security of communication with the user device as the connection destination; and
entering an output request from the user device with security established and output information from the user device, determining whether the output request from the user device with security established is valid, and operating the output information according to the output request from the user device with security established when the output request is valid.
